(19) United States
(12) Patent Application Publication
(10) Pub. No.: US 2024/0306675 A1
(43) Pub. Date: Sep. 19, 2024

(54) Nutritional Plant-Based Foods and Beverages, Methods of Manufacture, and Methods of Treatment

(71) Applicant: Kiddiwinks Inc., Mt. Tremper, NY (US)

(72) Inventors: Stephanie Banham, Mt. Tremper, NY (US); Robert McMahon, Cincinnati, OH (US); Joana Wolos, Miami Beach, FL (US)

(21) Appl. No.: 18/264,811

(22) PCT Filed: Feb. 8, 2022
(86) PCT No.: PCT/US2022/015698

§ 371 Date: Aug. 9, 2023

Related U.S. Application Data
(60) Provisional application No. 63/148,120, filed on Feb. 10, 2021.

(51) Int. Cl. A23L 2/66; A23L 33/115; A23L 33/15; A23L 33/16; A23L 33/28

(52) U.S. Cl. CPC A23L 2/66; A23L 33/115; A23L 33/15; A23L 33/16; A23L 33/28

(57) ABSTRACT

A plant-based beverage is disclosed. The beverage comprises: (a) an amount of a first liquid; (b) an amount of an oat-derived protein; and (c) an amount of a chickpea-derived protein. In some embodiments, the beverage further comprises a prebiotic fiber. A method for making a plant-based beverage comprising: liquids mixed to make a liquid mixture comprising: an amount of water; an amount of liquid flavor; an amount of a plant-based oil; solids are added to the mixture comprising: an amount of oat-derived protein; an amount of chickpea-derived protein; agitating the mixture until the solids are dispersed in solution. A method of altering the microbiome in the gastrointestinal tract of a subject is disclosed. The method comprising: orally administering to the subject a liquid comprising: an oat protein and a chickpea protein; so as to alter the microbiome in the gastrointestinal tract of the subject as compared to an untreated control.

### CROSS-REFERENCE TO RELATED APPLICATIONS§

This application is a national phase entry under 35 U.S.C. § 371 of International Patent Application PCT/US2022/015698, filed Feb. 8, 2022, designating the United States of America and published in English as International Patent Publication WO 2022/173764 on Aug. 18, 2022, which claims priority to U.S. Provisional Patent No. 63/148,120 filed on Feb. 10, 2021, and titled Nutritional Plant-Based Foods and Beverages, Methods of Manufacture, and Methods of Treatment, the entireties of which are hereby incorporated by reference.

### TECHNICAL FIELD

The present invention relates to beverages. In particular, the invention relates to nutritional plant-based beverages, methods of manufacturing plant-based beverages, methods of treatment, and methods of use utilizing plant-based beverages.

### BACKGROUND

There is great interest in the development of plant-based foods and beverages. These foods and beverages generally require less resources and have less of an environmental impact when compared to animal-based products such as meats and milks. Moving towards plant-based diets will help with long-term sustainability.

In addition, plant-based diets tend to be healthier. Many individuals today fail to meet the recommended intakes of several key nutrients, including dietary fiber, protein, and specific vitamins and minerals. Unfortunately, current nutritional foods and beverages (even those derived from plants) often suffer from low solubility and nutrient density. Additionally, these current products are not designed to support the function of an individual's microbiome (the commensal bacterial populations present in the gastrointestinal tract). This is particularly important as the health of an individual's microbiome is a crucial factor in determining an individual's overall health and wellness.

There exists a need for nutritionally dense plant-based beverages that are attractive to consumers, have a low environmental impact, are sustainable, and/or maintain and support the growth and function of individuals' microbiomes. In at least some embodiments, this need can be filled by beverages incorporating, among other things, high-quality plant-based protein sources including oat and chickpea.

### SUMMARY

In a first aspect, the disclosure provides a plant-based beverage comprising: (a) an amount of a first liquid; (b) an amount of an oat-derived protein; and (c) an amount of a chickpea-derived protein. In some embodiments, the beverage further comprises a prebiotic fiber. In some embodiments, the prebiotic fiber is one of inulin, fructo-oligosaccharides, galactooligosaccharides. In some embodiments the prebiotic fiber is inulin. In some embodiments, the prebiotic fiber is a human milk oligosaccharide. In some embodiments, the human milk oligosaccharide is one of 2-fucosyllactose, 3-fucosyllactose, difucosyllactose, sialyllactose, 3′sialyllactose, 6′sialyllactose lacto-N-tetraose (LNT), and/or lacto-N-neotetraose. In some embodiments, the beverage further comprises an amount of fat. In some embodiments, the fat is a plant-based fat. In some embodiments, the fat is sunflower oil. In some embodiments, the beverage of any of the combinations previously described further comprises an amount of a vitamin. In some embodiments, the beverage of any of the combinations previously described further comprising an amount of a first mineral. In some embodiments the first liquid is apple juice. In some embodiments, the beverage of any of the combinations previously described contains an amount of oat-derived protein is between 0.01 percent and 6.2 percent of the total weight of the plant-based beverage. In some embodiments, the beverage of any of the combinations previously described contains an amount of chickpea-derived protein is between 0.01 percent and 6.2 percent of the total weight of the plant-based beverage.

In a second aspect, the disclosure provides a method for making a plant-based beverage comprising: a liquid mixing stage wherein, liquids are mixed to make a liquid mixture comprising: an amount of water; an amount of liquid flavor; an amount of a plant-based oil; a solid addition stage wherein, solids are added to the mixture comprising: an amount of oat-derived protein; an amount of chickpea-derived protein; agitating the mixture until the solids are dispersed in solution. In some embodiments, the solids further comprise at least one of sugar, cocoa powder, a prebiotic fiber, dicalcium phosphate, locust bean gum, sunflower lecithin, salt, vitamins, and minerals. In some embodiments, the prebiotic fiber is selected from the group comprising inulin, fructo-oligosaccharides, galactooligosaccharides, and 2-fucosyllactose, 3-fucosyllactose, difucosyllactose, sialyllactose, 3′sialyllactose, 6′sialyllactose lacto-N-tetraose (LNT), and/or lacto-N-neotetraose. In some embodiments, the method of making a beverage of any of the combinations previously described includes an emulsification stage. In some embodiments, the method of making a beverage of any of the combinations previously described includes a purification stage.

In a third aspect the disclosure provides a method of altering the microbiome in the gastrointestinal tract of a subject, the method comprising: orally administering to the subject a liquid comprising: an oat protein, a chickpea protein; and a prebiotic; so as to alter the microbiome in the gastrointestinal tract of the subject as compared to an untreated control.

The changes to the microbiome may include alterations in the amount of a bifidobacterial or a bacteroides in the gastrointestinal tract of the subject such that the amount is increased as compared to an untreated control. The bifidobacteria are selected from the group consisting of B. adolescentis, B. longum, B. bifidum, B. angulatum, and B. catenulatum. Alternatively, the bacteroides are selected from the group consisting of B. bouchesdurhonensis, B. faecis, B. rodentium, B. ovatus, B. cutis, B. stercoris, B. luhongahouii, and B. thetaiotaomicron.

In a second aspect, the disclosure provides a method of reducing gas production the gastrointestinal tract of a subject, the method comprising: orally administering to the subject a liquid comprising: an oat protein, a chickpea protein; and inulin; wherein the amount of gas produced in the gastrointestinal tract of the subject is reduced as compared to a control administered inulin alone.

In a third aspect, the disclosure provides a method of reducing pH in the intestinal tract of a subject, the method comprising: orally administering to the subject a liquid comprising: an oat protein, a chickpea protein; and a prebiotic; wherein the pH in the intestinal tract of the subject is reduced as compared to as compared to an untreated control. The method according to claim 6, wherein the pH is reduced by at least 5%. The method according to claim 6, wherein the pH is reduced by at least 0.4.

In a fourth aspect, the disclosure provides a method of altering the amount of a short chain fatty acid in the gastrointestinal tract of a subject, the method comprising: orally administering to the subject a liquid comprising: an oat protein, a chickpea protein; and a prebiotic; so as to alter the amount of the short chain fatty acid in the gastrointestinal tract of the subject as compared to an untreated control. In some embodiments, the short chain fatty acid is selected from the group consisting of acetate, propionate, and butyrate.

In a fifth aspect, the disclosure provides a method of reducing the amount of E. coli in the gastrointestinal tract of a subject, the method comprising: orally administering to the subject a liquid comprising: an oat protein, a chickpea protein; and a prebiotic; so as to reduce the amount of E. coli in the gastrointestinal tract of the subject as compared to an untreated control.

The changes to the microbiome of the subject occur where the subject is a human. The changes to the microbiome of the subject occur where the human subject is a juvenile.

The amount of oat protein is between 0.01 and 6.2 weight percent of the liquid. The amount of chickpea protein is between 0.01 and 6.2 weight percent of the liquid. The combined amount of oat protein and chickpea protein is from 1.07 to 6.9 weight percent of the liquid.

A plant-based beverage can include an amount of a first liquid, an amount of an oat-derived protein, an amount of a chickpea-derived protein, an amount of a prebiotic, an amount of an at least one vitamin, an amount of an at least one mineral and/or an amount of a fat.

In some embodiments, the fat is a plant-based fat. In some embodiments, the first liquid is apple juice.

In some embodiments the total amount of oat-derived protein and chickpea-derived protein is between and inclusive of 1.07 and 6.9 percent of the total weight of the plant-based beverage.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a graph of the absolute pH across donors (±standard error of means indicated by error flags) on/during different moments of the 48 h fermentation. Five test ingredients, a negative control (blank) and a positive control (inulin) were tested.

FIG. 2 is a graph of pH changes across donors (±standard error of means indicated by error flags) on/during different moments of the 48 h fermentation. Five test ingredients, a negative control (blank) and a positive control (inulin) were tested.

FIG. 3 is a graph of Average gas pressure buildup (kPa) in the reactors across donors (±standard error of means indicated by error flags) during different intervals of the 48 h fermentation. Five test ingredients, a negative control (blank) and a positive control (inulin) were tested.

FIG. 4 is a graph of Average acetate production (mM) across donors (±standard error of means indicated by error flags) during different intervals of the 48 h fermentation.

Five test ingredients, a negative control (blank) and a positive control (inulin) were tested.

FIG. 5 is a graph of Average propionate production (mM) across donors (±standard error of means indicated by error flags) during different intervals of the 48 h fermentation. Five test ingredients, a negative control (blank) and a positive control (inulin) were tested.

FIG. 6 is a graph of Average butyrate production (mM) across donors (±standard error of means indicated by error flags) during different intervals of the 48 h fermentation. Five test ingredients, a negative control (blank) and a positive control (inulin) were tested.

FIG. 7 is a graph of Average bCFA production (mM) across donors (±standard error of means indicated by error flags) during different intervals of the 48 h fermentation. Five test ingredients, a negative control (blank) and a positive control (inulin) were tested.

FIG. 8 is a graph of Average lactate production and consumption (mM) across donors (±standard error of means indicated by error flags) during different intervals of the 48 h fermentation. Five test ingredients, a negative control (blank) and a positive control (inulin) were tested.

FIG. 9 is a graph of Absolute abundances (expressed as cells/g fecal material) of members of the gut microbiome in the fecal material of the selected donors at the bacterial phylum level. <LOQ=below Limit of Quantification.

FIG. 10 is a graph of Average abundances (cells/ml) (across three donors) of the different bacterial phyla at 24 h in all conditions (error bars reflect SEM across donors). Five products, a negative control (blank) and a positive control (inulin) were tested.

FIG. 11 is a graph of Average abundances (cells/ml) (across three donors) of the different bacterial phyla at 48 h in all conditions (error bars reflect SEM across donors). Five products, a negative control (blank) and a positive control (inulin) were tested.

### DETAILED DESCRIPTION

[Use qualifiers whenever a statement does not apply to the full breadth of the claims. For example, use the following phrases: “Preferably,” “More preferably,” “Such as,” “For example” and “Typically.” Also, mention as many alternative embodiments as possible.]

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

“or”, in reference to a list of two or more items, covers all of the following interpretations of the word: any of the items in the list, all of the items in the list, and any combination of the items in the list;

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

“comprise”, “comprising”, and the like are to be construed in an inclusive sense, as opposed to an exclusive or exhaustive sense; that is to say, in the sense of “including, but not limited to”;

Where a component is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which perform the function of the described component.

As used herein, “prebiotic” is meant to refer to a substrate that is selectively utilized by host microorganisms conferring a health benefit.

As used herein “oat” is a plant of an Avena sp.

As used herein “oat protein” or “oat-derived protein” is protein that is isolated from oats or protein that that has been isolated from oats and hydrolyzed. In some embodiments, the degree of hydrolysis as at least 2. In further embodiments, the degree of hydrolysis is at least 5.

As used herein “chickpea” is a plant of a Cicer sp.

As used herein “chickpea protein” or “chickpea-derived protein” is protein that is isolated from chickpea or protein that that has been isolated from chickpea and hydrolyzed. In some embodiments, the degree of hydrolysis as at least 2. In further embodiments, the degree of hydrolysis is at least 5.

Unless the context clearly requires otherwise, throughout the description and the claims:

“about” means plus or minus 5%.

In some embodiments, a nutritional formulation is presented as a beverage which can be consumed by humans. In some embodiments, the beverage can be consumed by young children and/or older adults. In some embodiments, the beverage can be consumed by various mammals including dogs, cats, and/or horses. In some embodiments, the beverage includes most, if not all, the necessary vitamins, minerals, and/or amino acids for a human.

In some embodiments, the beverage can include a combination of plant-based sources of protein and dietary fiber. In some embodiments, the beverage includes at least one liquid, oat, chickpea, a prebiotic, a source of plant-based fat, at least one vitamin, and/or at least one mineral.

In some embodiments, the liquid can be, but is not limited to, water, apple juice, sunflower oil, monk fruit syrup, galactooligosaccharide syrup, and/or algal or plant oil containing docosahexaenoic acid or a mixture of those liquids. In some embodiments, the beverage includes water, apple juice and sunflower oil.

In some embodiments, the prebiotic is inulin, fructo-oligosaccharides, galactooligosaccharides, xylooligosaccharides, and/or human milk oligosaccharides including, but not limited to, 2-fucosyllactose, 3-fucosyllactose, difucosyllactose, sialyllactose, 3′sialyllactose, 6′sialyllactose lacto-N-tetraose (LNT), and/or lacto-N-neotetraose. In some embodiments, the beverage includes inulin.

In some embodiments, the beverage can include prebiotic fibers, inulin, grain and/or legume derived complex polysaccharides. In some embodiments, the beverage can include prebiotic fibers, inulin, another prebiotic such as galacto-oligosaccharides or xylo-oligosaccharides, grain, and/or legume derived complex polysaccharides. In some embodiments, the beverage can include prebiotic fibers inulin, another prebiotic such as galactosaccharides, grain and legume derived polysaccharides, xylooligosaccharides, and/or human milk oligosaccharides including, but not limited to, 2-fucosyllactose, 3-fucosyllactose, difucosyllactose, sialyllactose, 3′sialyllactose, 6′sialyllactose lacto-N-tetraose (LNT), and/or lacto-N-neotetraose.

In some embodiments, the ratio between the human milk oligosaccharides and prebiotic fibers can be between and inclusive of 1:50 and 1:500. In some embodiments, the ratio between the human milk oligosaccharides and prebiotic fibers is between about 1:50 and about 1:500.

In some embodiments the amount of the prebiotic is between and inclusive of 0.07 and 3.4 percent of the total weight of said plant-based beverage. In some embodiments, the amount of the prebiotic is between about 0.07 and 3.4 percent of the total weight of the plant-based beverage. In some embodiments the amount of the prebiotic is between and inclusive of 1 and 2.2 percent of the total weight of said plant-based beverage. In some embodiments, the amount of the prebiotic is between about 1 percent and about 2.2 percent of the total weight of the pant-based beverage.

In some embodiments, the source of plant-based fat is sunflower oil. In some embodiments, the beverage includes docosahexaenoic acid. In some embodiments, the vitamin is vitamin D.

In some embodiments, the beverage includes sugar, cocoa powder, dicalcium phosphate, locust bean gum, sunflower lecithin, and/or sea salt.

In at least some embodiments, the nutritional beverage is a stable emulsion of mixed plant-based proteins from oat and chickpea. In some embodiments, the chickpea is in the form of chickpea protein isolate. In some embodiments, the emulsion includes plant-derived prebiotics and/or dietary fibers.

In some embodiments the amount of oat-derived protein is between and inclusive of 0.01 and 6.2 percent of the total weight of said plant-based beverage. In some embodiments, the amount of oat derived protein is between about 0.01 and about 6.2 percent of the total weight of the plant-based beverage. In some embodiments the amount of oat-derived protein is between and inclusive of 0.014 and 3.8 percent of the total weight of said plant-based beverage. In some embodiments, the amount of oat derived protein is between about 0.014 and about 3.8 percent of the total weight of the plant-based beverage. In some other embodiments, the amount of oat-derived protein is between and inclusive of 0.02 and 3.8 percent of the total weight of said plant-based beverage. In some embodiments, the amount of oat derived protein is between about 0.02 and about 3.8 percent of the total weight of the plant-based beverage. In some embodiments, the amount of oat derived protein is about 0.74 percent of the total weight of the plant-based beverage.

In some embodiments, the amount of chickpea-derived protein is between and inclusive of 0.01 and 6.2 percent of the total weight of said plant-based beverage. In some embodiments, the amount of chickpea-derived protein is between about 0.01 and about 6.2 percent of the total weight of the plant-based beverage. In some embodiments the amount of chickpea-derived protein is between and inclusive of 0.014 and 3.9 percent of the total weight of said plant-based beverage. In some embodiments, the amount of chickpea-derived protein is between about 0.014 and about 3.9 percent of the total weight of the plant-based beverage. In some embodiments the amount of chickpea-derived protein is between and inclusive of 0.02 and 3.8 percent of the total weight of said plant-based beverage. In some embodiments, the amount of chickpea-derived protein is between about 0.02 and about 3.8 percent of the total weight of the plant-based beverage.

In some embodiments of the beverage the ratio of oat-derived protein to chickpea-derived protein is between and inclusive of 10:90 to 90:10 by weight. In some embodiments of the beverage the ratio of oat-derived protein to chickpea-derived protein is between about 10:90 to about 90:10 by weight. In some embodiments, the ratio of oat-derived protein to chickpea-derived protein is between and inclusive of 25:75 to 75:25 by weight. In some embodiments of the beverage the ratio of oat-derived protein to chickpea-derived protein is between about 25:75 to about 75:25 by weight.

In some embodiments, the nutritional beverage can include animal-based ingredients such as milks.

In at least some embodiments, the nutritional beverage supports the microbiome in humans and/or other vertebrates including domestic mammals as well as production mammals.

In some embodiments, the nutritional beverage increases the production of short-chain fatty acids such as propionate, butyrate and or acetate. In some embodiments, the nutritional beverage increases the production of short-chain fatty acids such as propionate, butyrate and or acetate by 5% to 50% between 1 to 24 hours after administration of the beverage. In some embodiments, the nutritional beverage increases the production of short-chain fatty acids such as propionate, butyrate, and/or acetate by about 5% to about 50% between 1 to 24 hours. In some embodiments, the nutritional beverage increases the production of short-chain fatty acids such as propionate, butyrate, and/or acetate by 5% to about 50% between about 1 hour to about 24 hours. In some embodiments, the nutritional beverage increases the production of short-chain fatty acids such as propionate, butyrate, and/or acetate by about 5% to about 50% between about 1 hour to about 24 hours. In some embodiments, the nutritional beverage increases the production of short-chain fatty acids such as propionate, butyrate and or acetate by 10 to 25% between 1 to 24 hours after administration of the beverage. In some embodiments, the nutritional beverage increases the production of short-chain fatty acids such as propionate, butyrate, and/or acetate by about 10% to about 25% between 1 to 24 hours. In some embodiments, the nutritional beverage increases the production of short-chain fatty acids such as propionate, butyrate, and/or acetate by 10% to about 25% between about 1 hour to about 24 hours. In some embodiments, the nutritional beverage increases the production of short-chain fatty acids such as propionate, butyrate, and/or acetate by about 10% to about 25% between about 1 hour to about 24 hours.

In some embodiments, the nutritional beverage lowers the pH levels in fecal samples. In some embodiments, the nutritional beverage lowers the pH levels in fecal samples between and inclusive of 0.1 to 0.5 pH. In some embodiments, the nutritional beverage lowers the pH levels in fecal samples between about 0.1 pH to about 0.5 pH. In some embodiments, the nutritional beverage increases the growth of specific bacteria species including lactobacillus, bifidobacteria, clostridia, and other organisms in the gastrointestinal tract.

In some embodiments, a nutritional beverage can be created according to the methods discussed below.

In some embodiments, the method involves a Liquid Mixing Stage. In some embodiments, Liquid Mixing Stage involves mixing a predetermined amount of liquids, including, but not limited to, water, liquid flavor, and/or sunflower oil to create a liquid mixture. In some embodiments, the mixing is performed in a stainless-steel mix tank. In some embodiments, apple juice concentrate and/or other sweeteners are combined at the Liquid Mixing Stage to create the liquid mixture.

In some embodiments, the method involves a Solid Addition Stage. In Solid Addition Stage various solids, including powders can be added to the liquid mixture. In some embodiments, a predetermined amount of oat powder, chickpea protein powder, sugar, cocoa powder, inulin, dicalcium phosphate, locust bean gum, sunflower lecithin, sea salt and/or a blend of vitamins and/or minerals are slowly added to the liquid mixture. In some embodiments, the completed mixture is agitated until most of, if not all of, the solids are dispersed into the solution. In some embodiments, this takes about five minutes.

In some embodiments, the method involves an Emulsification Stage. In some embodiments the completed mixture is transferred to a two-step homogenizer to achieve a small, uniform droplet size emulsion. In some embodiments, the method involves preheating the mixture. In some embodiments, the mixture is preheated to about 85° C.

In some embodiments, the method involves a Purification Stage. In some embodiments the Purification Stage involves pasteurizing the emulsion. In some embodiments, the emulsion is processed at an ultra-high temperature for a short time. In some embodiments the high temperature is between and inclusive of 135-150° C. In some embodiments, the high temperature is between about 135° C. to about 150° C. In some embodiments the high temperature is between and inclusive of 135-140° C. In some embodiments, the high temperature is between about 135° C. to about 140° C. In some embodiments, the emulsion is only exposed to the high temperature for a short period of time. In some embodiments, the period of time is between and inclusive of 1-3 seconds. In some embodiments, the period of time is between about 1 seconds to about 3 seconds.

In some embodiments, the method involves a First Cooling Stage. In some embodiments, the First Cooling Stage involves trim cooling the emulsion to between and inclusive of 60-65° C. In some embodiments, the First Cooling Stage involves trim cooling the emulsion to about 60° C. to about 65° C. In some embodiments, the First Cooling Stage involves trim cooling the emulsion to between and inclusive of 61-63° C. In some embodiments, the emulsion is cooled to about 61° C. to about 63° C.

In some embodiments, the method involves a Re-Homogenization Stage. In some embodiments, the Re-Homogenization Stage helps ensure the stability of the protein composition in the product. In some embodiments, a two-stage homogenization process is used.

In some embodiments, the method involves a Second Cooling Stage. In some embodiments, the Second Cooling Stage involves rapidly cooling the emulsion to between and inclusive of 10° C. to 27° C. In some embodiments, the Second Cooling Stage involves rapidly cooling the emulsion to about 10° C. to about 27° C. In some embodiments, the emulsion is cooled to between and inclusive of 10° C. to 15° C. In some embodiments, the emulsion is cooled to about 10° C. to about 15° C. In some other embodiments, the emulsion is cooled to between and inclusive of 16° C. to 27° C. In some other embodiments, the emulsion is cooled to between about 16° C. to about 27° C.

In some embodiments, the method involves a Packing Stage. In some embodiments, the Packing Stage involves packaging the production into aseptic packaging and sealing said packaging.

Throughout the following description, specific details are set forth in order to provide a more thorough understanding of the invention. However, the invention can be practiced without these particulars. In other instances, well-known elements have not been shown or described in detail to avoid unnecessarily obscuring the description. Accordingly, the specification and drawings are to be regarded in an illustrative, rather than a restrictive sense.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

The microbiota of the gut is influenced by the substances that are consumed. Different microorganisms are better adapted to feeding on different substances. The inventors have conducted studies utilizing different amounts of plant derived products and observed the changes to the growth and concentrations of differing microorganisms.

### Material and Methods

### Preservation of Fecal Samples

Fecal material was collected from three healthy donors (Table 1).

TABLE 1

| Donor | Age (y) | Sex |
|---|---|---|
| A | 9 | Male |
| B | 9 | Female |
| C | 9 | Female |

Fecal suspensions were prepared and mixed with an in-house optimized cryoprotectant, i.e. a modified version of the cryoprotectant developed by Hoefman et al. (2013). The obtained suspensions were aliquoted for the different project phases (current phase and potential follow-up phases), flash frozen and then preserved at −80° C. (cryostock). Just before the experiment, an aliquot was defrosted and immediately added to the reactors. Use of aliquoted cryostocks of a single fecal suspension ensures that identical microbial communities are obtained in each aliquot, and thus that an identical inoculum is used throughout the different project phases. Moreover, preservation of aliquots from the start ensures that each aliquot undergoes only one freeze-thawing cycle before being introduced into the reactors. These actions ensure optimal reproducibility.

### Pre-Digestion

Oat grain flour (OGF) and chickpea flour (CPF) contain a fraction of digestible compounds that in vivo is absorbed at the level of the small intestine upon their conversion to small molecules. Hence, pre-digestion was considered relevant for this study. To optimally compare results with positive control inulin, inulin was pre-digested also. During pre-digestion, the products were exposed to conditions that simulate oral, gastric and small intestinal passage. Simulation of small intestinal absorption was performed by means of dialysis with 3.5 kDa membranes.

To ensure the quality of its digestion protocols, ProDigest updated its digestion methods based on a consensus protocol, developed within a large European framework (COST Action InfoGest). The latter describes a static digestion method with the aim to enhance comparison of digestion experiments across research teams (Mackie and Rigby, 2015). ProDigest further improved this digestion method by incorporating more accurate pH profiles and by simulating small intestinal absorption by means of a dialysis approach.

### Short-Term Colonic Incubations

A short-term screening assay typically consists of an incubation of a single dose of a test compound under conditions representative for the proximal large intestine, using a representative bacterial inoculum from a human donor as microbial source.

After pre-digestion, five OGF/CPF mixes were prepared according to the ratios in Table 2. At the start of the experiment, each of the five product mixes (Table 2) and inulin were added with a carbohydrate-depleted nutritional background medium (containing basal nutrients of the colon including peptone, yeast extract, mucin and L-cystein) to the reactors, so that total product concentration was 5 g/L (concentration not taking into account product absorption during dialysis) 5. The blank condition consisted of the carbohydrate-depleted nutritional background medium without test products, to assess baseline fermentation (i.e. fermentation of nutrients of the background medium). Then, 10% (v/v) of a cryostock containing 7.5% fecal inoculum of each of the investigated donors (which served as microbial source) was added, bringing the total volume in the reactors to 70 mL

TABLE 2

| Treatment | Oat grain flour | Chickpea flour |
|---|---|---|
| OGF | 100% | — |
| 75/25 OGF/CPF | 75% | 25% |
| 50/50 OGF/CPF | 50% | 50% |
| 25/75 OGF/CPF | 25% | 75% |
| CPF | — | 100% |

Reactors were incubated for 48 h at 37° C., under continuous mild shaking (90 rpm) and anaerobic atmosphere. The incubations were performed in fully independent reactors with sufficiently high volume to not only ensure robust microbial fermentation, but also to enable the collection of multiple samples over time. Sample collection enables assessment of metabolite production and thus to understand the complex microbial interactions that are taking place.

### Endpoints of the Study

An assessment was made of the change in pH, and of gas-, SCFA- and lactate-production at the start of the incubation (0 h) and after 6 h, 24 h and 48 h. Quantitative Illumina sequencing was performed to assess treatment effects on the gut microbial community at the start of the incubation (0 h) and after 24 h and 48 h.

### Overall Fermentative Activity

pH: the degree of acidification during the experiment is a measure for the intensity of bacterial metabolism and is used as a process control parameter. The pH of the incubations provides a rough indication about the speed of fermentation of the test products. Each measurement was done in single repetition.

Gas production: the incubations were performed in closed systems, which allows to measure accumulation of gases in the headspace with a pressure meter. Gas production is a measure of microbial activity, and thus of the speed of fermentation. H₂ and CO₂ are the first gases to be produced; they can subsequently be utilized as substrates for CH₄ production, reducing the gas volume. H₂ can also be utilized to reduce sulfate to H₂S, resulting from proteolytic fermentation 6. As a result, N₂, O₂, CO₂, H₂ and CH₄ constitute for 99% the volume of intestinal gas. The remaining 1% consists of NH₃, H₂S, volatile amino acids and short chain fatty acids. Each measurement was done in single repetition.

### Changes in Microbial Metabolite Production

Short chain fatty acid analysis: The pattern of SCFA production is an assessment of the microbial carbohydrate metabolism (acetate, propionate and butyrate) or protein metabolism (branched CFA) and can be compared to typical fermentation patterns for normal GI microbiota. Quantitative analysis of the SCFA is done by means of capillary gas chromatography, coupled with a flame ionization detector (FID). The isolation of SCFA is performed by liquid-liquid extraction. Each measurement was done in single repetition.

Lactate analysis: the human intestine harbors both lactate-producing and lactate-consuming bacteria. Lactate is produced by lactic acid bacteria and decreases the pH of the environment, thereby also acting as an antimicrobial agent. It can also be rapidly converted into propionate and butyrate by other microorganisms. Determination of lactate concentrations was performed using the Enzytec™ kit (R-Biopharm). Each measurement was done in single repetition.

### Changes in Community Composition (16S-Targeted Illumina Sequencing)

The 16S rRNA gene consists of variable and conserved regions, spread over the gene. Due to their key role in protein expression, the conserved regions are characterized by very low evolutionary rates. Any mutations that occurred in these regions during evolution have inevitably led to the death of the corresponding organism. Conservation of these 16S rRNA gene sequences allows the design of universal primers targeting the complete bacterial pool in a sample. Next to these conserved gene regions, the 16S rRNA gene also contains nine variable regions (V1-V9), which are characterized by a much higher evolutionary rate. These gene regions are typically less essential for the survival of the organism, which is why any mutations in these regions did not lead to death of the organism during evolution. Considering their higher evolutionary rates, these gene regions are typically used to distinguish between different taxonomic groups of bacteria.

### 16S-Targeted Illumina Sequencing

The methodology applied by ProDigest involves primers that span 2 hypervariable regions (V3-V4) of the 16S rRNA gene, i.e. 341F (5′-CCTACGGGNGGCWGCAG-3′) and 785R (5′-GACTACHVGGGTATCTAAKCC-3′). Using a pair-end sequencing approach, sequencing of 2×250 bp resulted in 424 bp amplicons. Such fragments are taxonomically more informative than smaller fragments. Read assembly and cleanup was largely derived from the MiSeq SOP described by the Schloss lab. Briefly, mothur (v.1.44.3) was used to assemble reads into contigs, perform alignment-based quality filtering (alignment to the mothur-reconstructed SILVA SEED alignment, v138), remove chimeras (vsearch v2.13.3), assign taxonomy using a naïve Bayesian classifier and SILVA NR v138_1 and cluster contigs into OTUs at 97% sequence similarity. All sequences that were classified as Eukaryota, Archaea, Chloroplasts and Mitochondria were removed. Also, if sequences could not be classified at all (even at (super)Kingdom level) they were removed. The most abundant sequence within an OTU was picked as the representative. Reads with maximum abundances of only 5 across samples were removed, as they were supposedly artefacts or bacteria that were not having any biological impact. For the most abundant OTUs, the obtained consensus sequences were classified manually through the RDP web interface using the RDP SeqMatch tool. The database search was restricted to isolates (uncultured organisms were not taken into account) with only near-full-length and good quality sequences.

### Quantification of Total Bacterial Cells by Flow Cytometry

Samples that were analyzed with Illumina sequencing were also analyzed with flow cytometry to determine the number of total bacterial cells, thus allowing to convert the proportional values obtained with Illumina into absolute quantities. Samples were analyzed on a BD Facs verse. The samples were run using the high flow rate. Bacterial cells were separated from medium debris and signal noise by applying a threshold level of 200 on the SYTO channel. Proper parent and daughter gates were set to determine all populations.

### Statistics

To assess whether treatment effects in terms of the investigated endpoints were significantly different from the reference conditions (blank/inulin), paired two-sided T-tests were performed, considering the different donors as replicates (n=3). Each of the five treatments was compared with the blank and with the positive control inulin, and an effect was considered significant if the obtained p-value was below 0.05.

### Results

Note that when statistics are mentioned along the text, they are derived from the statistics shown in Table 3 and Table 4.

### Overall Fermentative Activity

### pH Decrease

Monitoring the pH during a colonic incubation provides a good indication of the production of SCFA, lactate and ammonium (NH₄+). In general, a pH drop is observed initially due to the formation of SCFA/lactate. This pH drop is often followed by a pH increase due to proteolytic fermentation, which results in the production of amongst others NH₄+, and due to conversion of stronger acids into weaker acids through cross-feeding (for instance acetate/lactate-to-propionate/butyrate conversion).

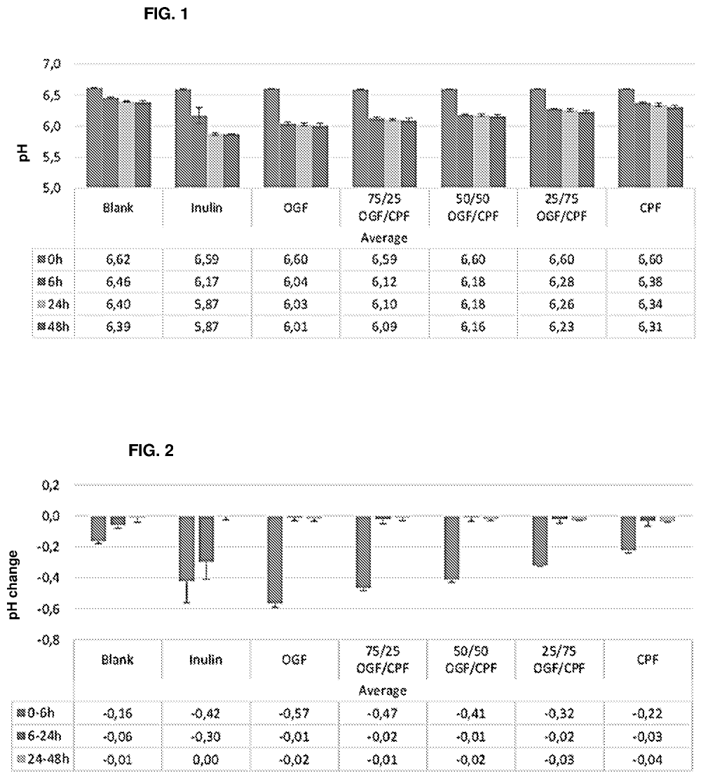

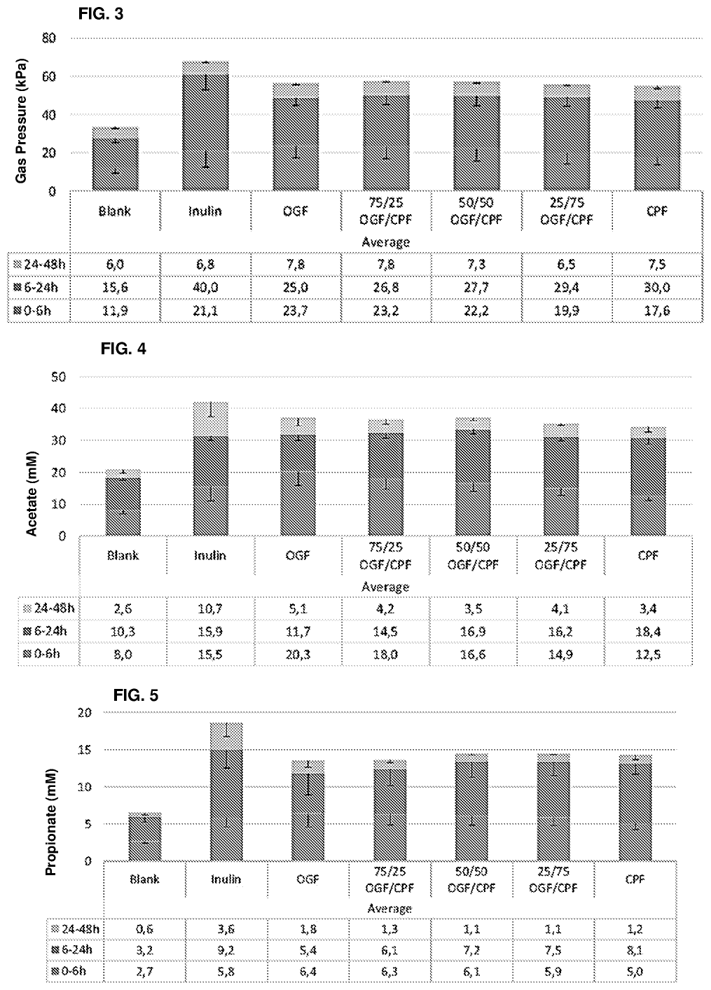

All incubations proceeded under optimal pH conditions. Overall, pH varied between 5.84-6.63 (FIG. 1), which is optimal to support growth of a wide diversity of gut microbial community members and to enable cross-feeding interactions, if any. All products, except inulin, resulted in stronger pH decreases (FIG. 2) than the blank at 6 h, indicating efficient substrate fermentation. The extent of the pH decrease was related with OGF content of the products: the higher the OGF content, the stronger the pH decrease. For inulin, a significant pH decrease was observed between 6-24 h, which resulted in the lowest pH at 24 h amongst all test products. This suggests that inulin fermentation evolved more gradual than fermentation of the test products.

### Gas Production

Besides pH decrease, gas production is a measure of overall microbial activity, and thus of fermentation speed (FIG. 3). Any gas produced in the blank conditions likely resulted from proteolytic fermentation of peptides and proteins of the background nutritional medium.

All products (including inulin) stimulated gas production. Although not statistically significant, stimulatory effects were observed already at 6 h of incubation. Each product yielded significantly less gas than inulin. Apart from the fact that initial gas production seemed to decrease with increasing CPF content, no major differences were observed between the test products.

### Changes in Microbial Metabolites

### Short-Chain Fatty Acids

SCFA production results from carbohydrate metabolism in the colon and is related with various health effects. The most abundantly produced SCFAs include acetate, propionate and butyrate. Whereas acetate can be used as an energy source for the host and as a potential substrate for lipid synthesis in the body, propionate reduces cholesterol and fatty acid synthesis in the liver (beneficial effect on metabolic homeostasis). Butyrate on the other hand, is a major energy source for colonocytes and induces differentiation in these cells (related to cancer prevention). Positive effects of the investigated substrates on SCFA production therefore include increases of acetate, propionate and/or butyrate.

Acetate can be produced by many different gut microbes (including amongst others Bifidobacterium spp., Bacteroides spp. and Lactobacillus spp.) and is a primary metabolite generated from fermentation of prebiotic substrates. Results are shown in FIG. 4. All products yielded more acetate than the blank at 6 h (not statistically supported for inulin and OGF), indicating efficient substrate fermentation. At 24 h and 48 h, all products (including inulin) yielded significantly more acetate than the blank, but due to interindividual differences none of the products yielded significantly more acetate than inulin. In donors A and C, initial acetate concentrations increased with OGF content. Apart from that, no consistent differences were observed between the test products.

Propionate can be produced by different gut microbes, with the most abundant propionate producers being Bacteroides spp., Akkermansia muciniphila and Veillonellaceae. However, functional redundancy in propionate production is lower compared to acetate. As a consequence, lacking a specific propionate-producing population is expected to have more impact on propionate levels than lacking a specific acetate-producing population on acetate levels, and higher interindividual differences may occur. Results are shown in FIG. 5. All products yielded more propionate than the blank at 6 h (statistically supported only for CPF). At 24 h and 48 h, all products (including inulin) yielded more propionate than the blank (statistically supported only for 25/75 OGF/CPF and for CPF), but none of the products consistently yielded more propionate than inulin. In donors A and C, propionate production increased with CPF content, while the opposite was observed in donor B.

Butyrate is mostly produced by members of the Lachnospiraceae and Ruminococcaceae families. In a process called cross-feeding, these microbes convert acetate and/or lactate (along with other substrates) to the health-related butyrate. Like propionate, functional redundancy in butyrate production is lower compared to acetate, and higher interindividual differences may occur. Results are shown in FIG. 6. Butyrate was mostly produced between 6-48 h. All products (including inulin) yielded more butyrate than the blank (not statistically supported for inulin and OGF), but none of the products consistently yielded more butyrate than inulin (due to interindividual differences). In donors A and C, butyrate production increased with OGF content. In donor B, similar butyrate concentrations were obtained for all test products.

Marker for protein metabolism: branched CFA

Less abundant fatty acids include branched CFA (isobutyrate, isovalerate and isocaproate). Branched CFA production results from proteolytic microbial activity, which is associated with formation of toxic by-products such as p-cresol. Therefore, high branched CFA production in the colon has been associated with detrimental health effects. As a consequence, products that reduce branched CFA and ammonium production are considered health beneficial.

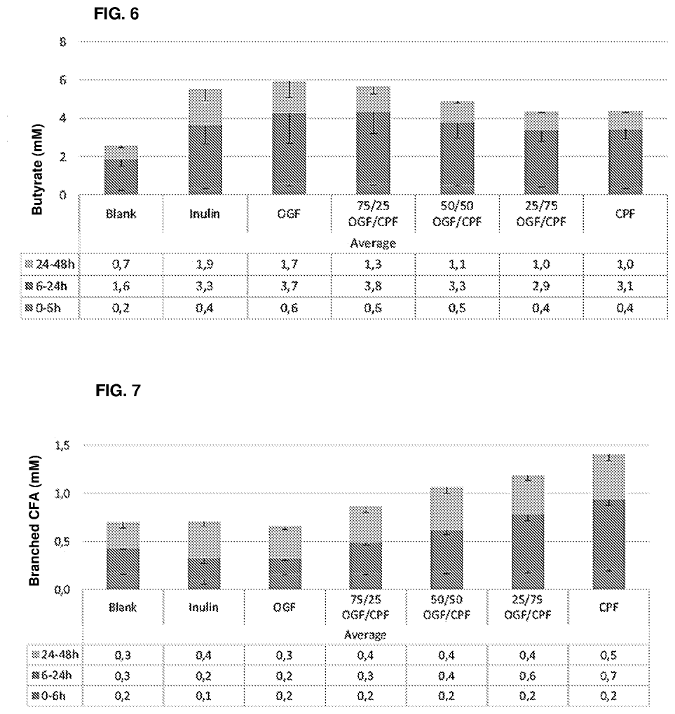

Branched CFA (bCFA) production mostly occurred between 6-48 h (FIG. 7). All product mixes with CPF yielded more bCFA than the blank, and the bCFA concentration increased with CPF content of the products. CPF yielded significantly more bCFA than inulin.

### Lactate Production

The human intestine harbors both lactate-producing and lactate-consuming bacteria. Lactate is produced by lactic acid bacteria (including bifidobacteria and lactobacilli) and decreases the pH of the environment. Especially at low pH, lactate can exert strong antimicrobial effects against pathogens, as protonated lactic acid can penetrate the microbial cell after which it dissociates and releases protons within the cell, resulting in acidification and microbial cell death. Another beneficial effect of lactate results from its conversion to butyrate and/or propionate by specific micro-organisms. As different microbial species thus produce and convert lactate, an increase of lactate concentration can both result from an increased production as well as a decreased conversion.

Effects of the products on lactate-production are illustrated in FIG. 8. Positive values indicate that the lactate-production rate was higher than the lactate-consumption rate within a given timeframe (resulting in accumulation of lactate, typically observed during early stages of the incubation when plenty of substrate is available); negative values indicate that the lactate-consumption rate was higher than the lactate-production rate (resulting in consumption of accumulated lactate, typically observed during late stages of the incubation, when substrates become depleted and production of lactate no longer occurs).

All products (including inulin) stimulated lactate production (statistically significant only for OGF, 75/25 OGF/CPF and 50/50 OGF/CPF). Lactate production increased with OGF content of the product, which correlates the extents of the pH decreases. Although OGF and 75/25 OGF/CPF yielded more lactate than inulin in each donor, the effect was not statistically significant. In general, lactate was efficiently consumed by the end of the incubation, suggesting efficient cross-feeding interactions.

### Statistics of Fermentative and Microbial Activity

For each endpoint (pH, gas, SCFA and lactate), differences were calculated between treatment and blank/inulin and averages across the donors were presented in Table 3 and Table 4. These calculations were done on values obtained at 6 h, 24 h and 48 h of incubation. To assess whether these differences were statistically significant across the donors, paired T-tests were performed (§ Materials and Methods). If significant, those differences were indicated in bold. Finally, differences representing more pronounced saccharolytic fermentation for a given endpoint (often translated into health-promoting potential of the treatment) have been highlighted in grey, i.e.:

$$pH / bCFA < 0$$

$$gas / acetate / lactate / propionate / butyrate > 0$$

TABLE 3

| | | | 75/25 | 50/50 | 25/75 | |
|---|---|---|---|---|---|---|
| | Inulin | OGF | OGF/CPF | OGF/CPF | OGF/CPF | CPF |
| D0-6 h | | | | | | |
| pH | −0.26 | −0.40 | −0.30 | −0.25 | −0.16 | −0.06 |
| Gas (kPa) | 9.17 | 11.80 | 11.30 | 10.33 | 8.03 | 5.73 |
| Acetate (mM) | 7.50 | 12.24 | 9.94 | 8.57 | 6.91 | 4.45 |
| Propionate | 3.11 | 3.70 | 3.60 | 3.41 | 3.18 | 2.34 |
| (mM) | | | | | | |
| Butyrate (mM) | 0.15 | 0.36 | 0.35 | 0.28 | 0.21 | 0.14 |
| Total SCFA | 10.68 | 16.28 | 13.87 | 12.26 | 10.32 | 6.97 |
| (mM) | | | | | | |
| bSCFA (mM) | −0.08 | −0.02 | −0.01 | 0.00 | 0.02 | 0.04 |
| Lactate (mM) | 2.67 | 6.46 | 5.30 | 3.89 | 2.56 | 1.05 |
| D0-24 h | | | | | | |
| pH | −0.50 | −0.35 | −0.26 | −0.20 | −0.12 | −0.03 |
| Gas (kPa) | 33.57 | 21.17 | 22.47 | 22.40 | 21.80 | 20.10 |
| Acetate (mM) | 13.13 | 13.62 | 14.12 | 15.21 | 12.81 | 12.54 |
| Propionate | 9.07 | 5.83 | 6.44 | 7.42 | 7.43 | 7.19 |
| (mM) | | | | | | |
| Butyrate (mM) | 1.78 | 2.40 | 2.47 | 1.91 | 1.50 | 1.56 |
| Total SCFA | 23.88 | 21.75 | 23.09 | 24.74 | 22.09 | 21.80 |
| (mM) | | | | | | |
| bSCFA (mM) | −0.10 | −0.10 | 0.06 | 0.19 | 0.35 | 0.50 |
| D0-48 h/ | | | | | | |
| Production | | | | | | |
| pH | −0.49 | −0.36 | −0.26 | −0.21 | −0.14 | −0.06 |
| Gas (kPa) | 34.40 | 23.00 | 24.23 | 23.70 | 22.33 | 21.60 |
| Acetate (mM) | 21.18 | 16.15 | 15.69 | 16.13 | 14.29 | 13.37 |
| Propionate | 12.10 | 7.04 | 7.12 | 7.96 | 7.95 | 7.82 |
| (mM) | | | | | | |
| Butyrate (mM) | 3.00 | 3.39 | 3.10 | 2.35 | 1.78 | 1.83 |
| Total SCFA | 36.29 | 26.53 | 26.07 | 26.81 | 24.51 | 23.73 |
| (mM) | | | | | | |
| bSCFA (mM) | 0.01 | −0.05 | 0.17 | 0.37 | 0.49 | 0.71 |
| Lactate (mM) | 2.67 | 6.45 | 5.30 | 3.89 | 2.56 | 1.05 |

TABLE 4

| | | 75/25 | 50/50 | 25/75 | |
|---|---|---|---|---|---|
| | OGF | OGF/CPF | OGF/CPF | OGF/CPF | CPF |
| D0-6 h | | | | | |
| pH | −0.14 | −0.04 | 0.01 | 0.10 | 0.20 |
| Gas (kPa) | 2.63 | 2.13 | 1.17 | −1.13 | −3.43 |
| Acetate (mM) | 4.74 | 2.44 | 1.07 | −0.59 | −3.05 |
| Propionate (mM) | 0.59 | 0.49 | 0.30 | 0.07 | −0.77 |
| Butyrate (mM) | 0.21 | 0.20 | 0.13 | 0.06 | 0.00 |
| Total | 5.59 | 3.19 | 1.58 | −0.36 | −3.71 |
| SCFA (mM) | | | | | |
| bSCFA (mM) | 0.06 | 0.07 | 0.08 | 0.09 | 0.11 |
| Lactate (mM) | 3.79 | 2.63 | 1.23 | −0.11 | −1.62 |
| D0-24 h | | | | | |
| pH | 0.14 | 0.23 | 0.30 | 0.38 | 0.46 |
| Gas (kPa) | −12.40 | −11.10 | −11.17 | −11.77 | −13.47 |
| Acetate (mM) | 0.48 | 0.99 | 2.08 | −0.32 | −0.59 |
| Propionate (mM) | −3.24 | −2.62 | −1.65 | −1.64 | −1.88 |
| Butyrate (mM) | 0.62 | 0.69 | 0.13 | −0.28 | −0.22 |
| Total | −2.13 | −0.79 | 0.86 | −1.79 | −2.08 |
| SCFA (mM) | | | | | |
| bSCFA (mM) | 0.00 | 0.16 | 0.29 | 0.45 | 0.61 |
| D0-48 h/ | | | | | |
| Production | | | | | |
| pH | 0.13 | 0.23 | 0.28 | 0.35 | 0.43 |
| Gas (kPa) | −11.40 | −10.17 | −10.70 | −12.07 | −12.80 |
| Acetate (mM) | −5.04 | −5.49 | −5.05 | −6.90 | −7.82 |
| Propionate (mM) | −5.06 | −4.98 | −4.13 | −4.15 | −4.28 |
| Butyrate (mM) | 0.39 | 0.10 | −0.65 | −1.22 | −1.16 |
| Total | −9.76 | −10.21 | −9.48 | −11.78 | −12.56 |
| SCFA (mM) | | | | | |
| bSCFA (mM) | −0.05 | 0.16 | 0.36 | 0.48 | 0.70 |
| Lactate (mM) | 3.78 | 2.63 | 1.22 | −0.11 | −1.63 |

### Changes in Microbial Community Composition

Two techniques were combined according to Vandeputte et al. (2017) to map the community shifts induced by the treatments in large detail:

16S targeted Illumina sequencing, a DNA-based method by which the complete microbial DNA pool in a sample is sequenced, providing proportional abundances of different taxa with resolution at genus-species level.

Accurate quantification of total bacterial cells in the samples through flow cytometry.

Combining the high-resolution phylogenetic information of 16S targeted Illumina sequencing with accurate quantification of cell counts via flow cytometry results in quantitative enumeration of the different taxonomic entities inside the reactors.

The discussion will first focus on a description of the gut microbial communities of the three donors used in the experiment, followed by an assessment of the effects induced by the treatments.

### Community Composition of the Fecal Inocula

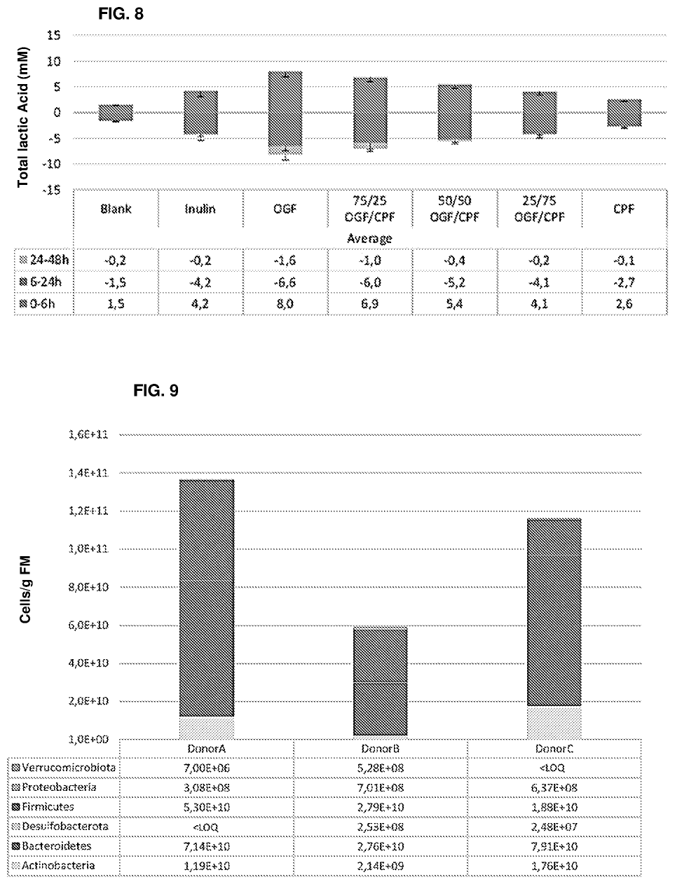

The gut microbial communities of the selected donors were mainly represented by three bacterial phyla, i.e. Actinobacteria, Bacteroidetes and Firmicutes (FIG. 9). Proteobacteria were present in all donors, but in lower abundances. Desulfobacterota were only detected in donors B and C; Verrucomicrobia were only detected in donors A and B. Microbial community composition at family level is provided in Table 5, and at genus-species level in Table 6.

TABLE 5
TABLE 5

| Phylum | Family | DonorA | DonorB | DonorC |
|---|---|---|---|---|
| Actinobacteria | Atopobiaceae | <LOQ | 8.25 | <LOQ |
| | Bifidobacteriaceae | 9.97 | 9.00 | 9.99 |
| | Coriobacteriaceae | 9.41 | 8.85 | 9.89 |
| | Coriobacteriales_Incertae_Sedis | <LOQ | 7.07 | <LOQ |
| | Eggerthellaceae | 7.89 | 8.27 | 7.84 |
| | uncultured | <LOQ | 7.82 | <LOQ |
| Bacteroidetes | Bacteroidaceae | 10.15 | 9.48 | 9.54 |
| | Bacteroidales_unclassified | <LOQ | 9.44 | <LOQ |
| | Barnesiellaceae | 8.73 | 8.66 | 7.90 |
| | Marinifilaceae | 8.38 | 9.08 | 7.30 |
| | Prevotellaceae | 10.73 | 10.21 | 10.87 |
| | Rikenellaceae | 9.43 | 9.52 | 9.02 |
| | Tannerellaceae | 8.76 | 8.80 | 8.38 |
| Desulfobacterota | Desulfovibrionaceae | <LOQ | 8.40 | 7.39 |
| Firmicutes | Acidaminococcaceae | 8.73 | 6.83 | <LOQ |
| | Anaerovoracaceae | 7.02 | 8.04 | 7.35 |
| | Butyricicoccaceae | 7.45 | 7.95 | 7.39 |
| | Christensenellaceae | 8.74 | 8.98 | 7.86 |
| | Clostridia_UCG-014_fa | <LOQ | 9.19 | <LOQ |
| | Clostridiaceae | 7.94 | 9.50 | 8.18 |
| | Defluviitaleaceae | 7.24 | 7.18 | <LOQ |
| | Enterococcaceae | <LOQ | <LOQ | <LOQ |
| | Erysipelatoclostridiaceae | 8.33 | 8.22 | 7.67 |
| | Erysipelotrichaceae | 8.64 | 9.11 | 8.25 |
| | Lachnospiraceae | 10.31 | 9.68 | 9.63 |
| | Lactobacilluseae | <LOQ | <LOQ | <LOQ |
| | Monoglobaceae | 7.24 | 7.48 | 7.24 |
| | Oscillospiraceae | 8.79 | 9.34 | 8.39 |
| | Oscillospirales_fa | 8.52 | 9.10 | 8.51 |
| | Peptostreptococcaceae | 7.87 | 9.02 | 9.03 |
| | RF39_fa | <LOQ | 8.62 | <LOQ |
| | Ruminococcaceae | 10.46 | 9.60 | 10.00 |
| | Selenomonadaceae | <LOQ | 9.06 | <LOQ |
| | Streptococcaceae | 8.19 | 7.68 | 7.39 |
| | UCG-010 | <LOQ | 7.34 | <LOQ |
| | Veillonellaceae | 8.77 | 9.75 | 9.37 |
| Proteobacteria | Enterobacteriaceae | <LOQ | 7.81 | 8.05 |
| | Morganellaceae | <LOQ | <LOQ | <LOQ |
| | Oxalobacteraceae | <LOQ | 8.07 | <LOQ |
| | Pasteurellaceae | <LOQ | 7.57 | <LOQ |
| | Sutterellaceae | 8.49 | 8.68 | 8.72 |
| Verrucomicrobiota | Akkermansiaceae | 6.84 | 8.72 | <LOQ |

TABLE 6

| Phylum | Family | OTU | Closely related species | DonorA | DonorB | DonorC |
|---|---|---|---|---|---|---|
| Actinobacteria | Bifidobacteriaceae | 3 | Bifidobacterium adolescentis | 9.90 | 8.60 | 9.72 |
| | | 10 | Bifidobacterium longum | 8.91 | 8.52 | 8.74 |
| | | 19 | Bifidobacterium bifidum | 8.70 | 8.36 | 8.71 |
| | | 11 | Bifidobacterium angulatum | <LOQ | <LOQ | 9.37 |
| | | 16 | Bifidobacterium | 7.72 | 6.71 | 9.06 |
| | | | (pseudo)catenulatum | | | |
| | Coriobacteriaceae | 26 | Collinsella aerofaciens | 9.40 | 8.85 | 9.89 |
| | Eggerthellaceae | 7 | Senegalimassilia faecalis | 7.54 | 8.09 | 7.44 |
| Bacteroidetes | Bacteroidaceae | 4 | Bacteroides | 9.99 | 9.16 | 8.85 |
| | | | bouchesdurhonensis | | | |
| | | 13 | Bacteroides faecis | 8.96 | 8.26 | 7.39 |
| | | 20 | Bacteroides rodentium | 9.10 | 6.83 | 7.09 |
| | | 9 | Bacteroides faecis | 8.68 | 8.58 | 8.34 |
| | | 12 | Bacteroides ovatus | 8.66 | 8.48 | 7.87 |
| | | 14 | Bacteroides cutis | 8.76 | 7.43 | 8.27 |
| | | 35 | Bacteroides stercoris | 8.22 | <LOQ | <LOQ |
| | | 21 | Bacteroides luhongzhouii | 8.13 | 8.01 | 7.65 |
| | | 30 | Bacteroides thetaiotaomicron | 7.15 | 7.79 | 7.09 |
| | | 17 | Bacteroides luhongzhouii | <LOQ | <LOQ | 8.46 |
| | Bacteroidales_unclassified | 44 | Bacteroides sp. | <LOQ | 9.40 | <LOQ |
| | Prevotellaceae | 6 | Prevotella hominis | 10.73 | 10.21 | 10.85 |
| | Tannerellaceae | 18 | Parabacteroides gordonii | 8.50 | 8.32 | 7.69 |
| | | 29 | Parabacteroides gordonii | 8.40 | <LOQ | <LOQ |
| Firmicutes | Clostridiaceae | 37 | Clostridium saudiense | 7.92 | 9.50 | 8.15 |
| | | 38 | Clostridium perfringens | <LOQ | 7.01 | 6.69 |
| | Erysipelotrichaceae | 8 | Holdemanella sp. | 8.61 | 9.11 | 7.65 |
| | Lachnospiraceae | 27 | Blautia faecicola | 8.38 | 8.19 | 7.81 |
| | | 25 | Lachnoclostridium pacaense | 8.05 | 7.27 | 8.18 |
| | Ruminococcaceae | 15 | Faecalibacterium sp. | 10.38 | 9.48 | 9.90 |
| | Selenomonadaceae | 2 | Megamonas hypermegale | <LOQ | 9.06 | <LOQ |
| | Veillonellaceae | 28 | Dialister invisus | 8.77 | 9.74 | <LOQ |
| | | 23 | Dialister massiliensis | <LOQ | <LOQ | 9.37 |
| Proteobacteria | Enterobacteriaceae | 1 | Escherichia coli, E. fergusonii, | <LOQ | 7.81 | 8.05 |
| | | | Shigella sonnei, S. flexneri, | | | |
| | | | Pseudescherichia vulneris | | | |
| | Sutterellaceae | 5 | Sutterella megalosphaeroides | 8.48 | 7.71 | 8.68 |
| | | 22 | Sutterella wadsworthensis | <LOQ | 8.57 | <LOQ |

### Community Shifts Induced by the Treatments

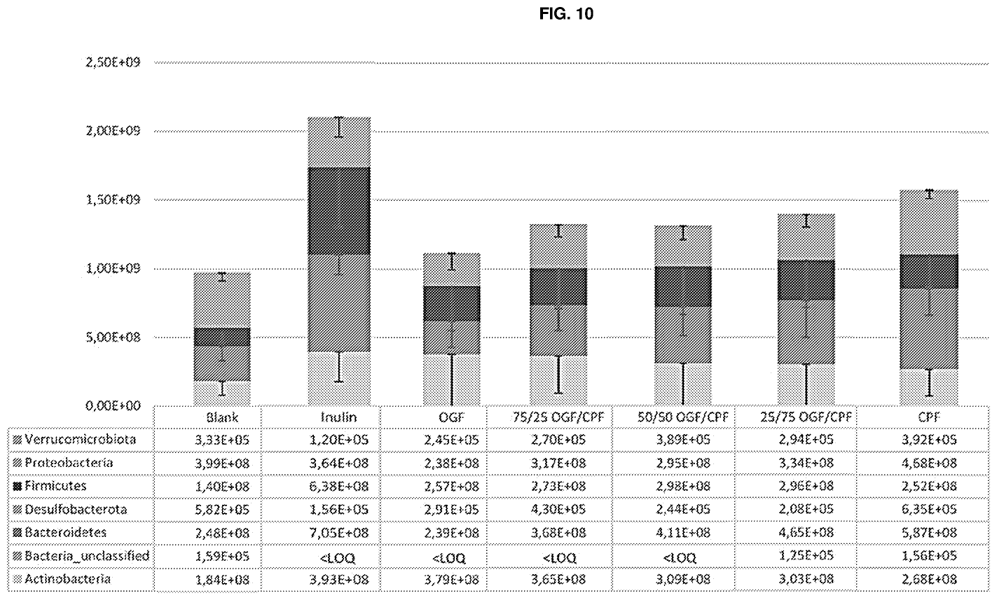

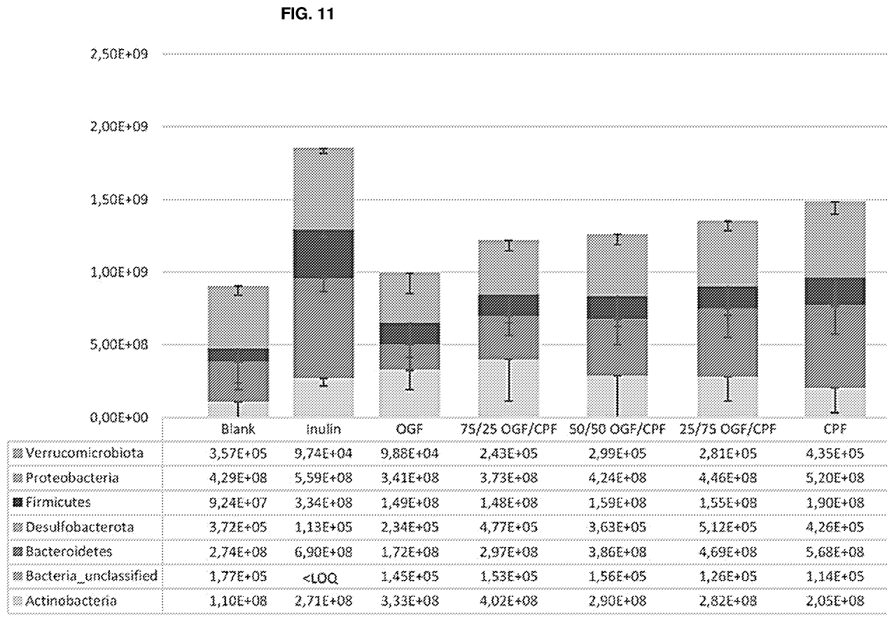

Samples were collected at 24 h and 48 h. To express how the products affected microbial community composition of the selected donors, the following calculations were made:
Differences between average absolute (logarithmic) abundances of the different families (Table 8-Table 9) and OTUs (Table 12-Table 15) in two treatments across donors; paired T-tests were performed to assess statistical relevance of an enrichment/inhibition.
Average absolute (logarithmic) abundances of the different families (Table 7) and OTUs (Table 10-Table 11) in the different conditions across donors; treatment effects at phylum level are shown in FIG. 10 and FIG. 11.

TABLE 7

| | | | | | | | | |
|---|---|---|---|---|---|---|---|---|
| | | | | | 75/25 | 50/50 | 25/75 | |
| | | | | | OGF/ | OGF/ | OGF/ | |
| Phylum | Family | Blank | Inulin | OGF | CPF | CPF | CPF | CPF |

24 h

| | | | | | | | | |
|---|---|---|---|---|---|---|---|---|
| Actinobacteria | Atopobiaceae | 5.06 | <LOQ | <LOQ | 5.08 | <LOQ | <LOQ | 5.07 |
| | Bifidobacteriaceae | 7.91 | 8.25 | 8.54 | 8.51 | 8.43 | 8.40 | 8.26 |
| | Coriobacteriaceae | 6.09 | 5.76 | 5.83 | 5.91 | 6.01 | 5.92 | 5.96 |
| | Coriobacteriales_Incertae_Sedis | <LOQ | <LOQ | <LOQ | <LOQ | <LOQ | <LOQ | <LOQ |
| | Eggerthellaceae | 7.89 | 8.23 | 7.50 | 7.56 | 7.52 | 7.57 | 7.81 |
| | uncultured | <LOQ | <LOQ | <LOQ | <LOQ | <LOQ | <LOQ | <LOQ |
| Bacteria | Bacteria_unclassified | 5.20 | <LOQ | <LOQ | <LOQ | <LOQ | 5.10 | 5.19 |
| unclassified | | | | | | | | |
| Bacteroidetes | Bacteroidaceae | 8.34 | 8.74 | 8.33 | 8.50 | 8.55 | 8.58 | 8.67 |
| | Bacteroidales_unclassified | 5.26 | <LOQ | 5.21 | 5.32 | 5.35 | 5.36 | 5.51 |
| | Barnesiellaceae | 5.56 | 5.06 | 5.36 | 5.42 | 5.32 | 5.43 | 5.62 |
| | Marinifilaceae | 5.71 | 5.28 | 5.15 | 6.19 | 6.27 | 6.41 | 6.69 |
| | Prevotellaceae | 5.86 | 7.22 | 6.07 | 6.78 | 7.04 | 7.44 | 7.80 |
| | Rikenellaceae | 6.70 | 6.54 | 6.70 | 6.91 | 6.83 | 6.94 | 7.13 |
| | Tannerellaceae | 7.26 | 6.62 | 7.01 | 7.37 | 7.31 | 7.27 | 7.41 |
| Desulfobacterota | Desulfovibrionaceae | 5.76 | 5.19 | 5.46 | 5.63 | 5.39 | 5.32 | 5.80 |
| Firmicutes | Acidaminococcaceae | 5.75 | 5.76 | 5.58 | 5.69 | 5.65 | 5.65 | 5.73 |
| | Anaerovoracaceae | <LOQ | <LOQ | <LOQ | <LOQ | <LOQ | <LOQ | <LOQ |
| | Butyricicoccaceae | 5.37 | 5.36 | 5.31 | 5.86 | 5.86 | 5.82 | 6.14 |
| | Christensenellaceae | 5.43 | 5.28 | 5.37 | 5.34 | 5.29 | 5.20 | 5.67 |
| | Clostridia_UCG-014_fa | 5.28 | 5.12 | 5.13 | 5.34 | 5.20 | 5.24 | 5.36 |
| | Clostridiaceae | 5.69 | 5.67 | 5.98 | 5.97 | 6.05 | 5.91 | 6.08 |
| | Defluviitaleaceae | <LOQ | <LOQ | <LOQ | <LOQ | <LOQ | <LOQ | <LOQ |
| | Enterococcaceae | 5.76 | 5.83 | 5.56 | 5.65 | 5.67 | 5.58 | 5.87 |
| | Erysipelatoclostridiaceae | <LOQ | <LOQ | 5.08 | 5.32 | 5.12 | 5.24 | 5.06 |
| | Erysipelotrichaceae | 6.64 | 7.68 | 7.25 | 7.40 | 7.11 | 7.01 | 7.01 |
| | Lachnospiraceae | 7.36 | 7.99 | 7.35 | 7.41 | 7.47 | 7.45 | 7.60 |
| | Lactobacillaceae | 5.17 | <LOQ | 5.45 | 5.45 | 5.29 | 5.24 | 5.11 |
| | Monoglobaceae | <LOQ | <LOQ | <LOQ | <LOQ | 5.43 | 5.35 | 5.99 |
| | Oscillospiraceae | 6.27 | 5.56 | 5.93 | 6.39 | 6.36 | 6.38 | 6.62 |
| | Oscillospirales_fa | 5.43 | <LOQ | <LOQ | <LOQ | 5.11 | 5.14 | 5.11 |
| | Peptostreptococcaceae | 5.73 | 5.59 | 5.43 | 5.51 | 5.27 | 5.61 | 5.72 |
| | RF39_fa | <LOQ | <LOQ | <LOQ | 5.08 | <LOQ | <LOQ | <LOQ |
| | Ruminococcaceae | 6.90 | 6.78 | 6.92 | 7.03 | 7.02 | 6.95 | 6.99 |
| | Selenomonadaceae | 6.22 | 6.41 | 6.37 | 6.35 | 6.38 | 6.38 | 6.33 |
| | Streptococcaceae | 5.25 | 5.60 | 5.37 | 5.52 | 5.64 | 5.54 | 5.69 |
| | UCG-010 | <LOQ | <LOQ | <LOQ | <LOQ | <LOQ | <LOQ | <LOQ |
| | Veillonellaceae | 6.51 | 6.78 | 6.34 | 6.38 | 6.51 | 6.52 | 6.71 |
| Proteobacteria | Enterobacteriaceae | 8.54 | 8.51 | 8.18 | 8.27 | 8.19 | 8.25 | 8.51 |
| | Morganellaceae | <LOQ | <LOQ | <LOQ | <LOQ | <LOQ | 5.24 | 5.11 |
| | Oxalobacteraceae | <LOQ | <LOQ | <LOQ | <LOQ | <LOQ | <LOQ | <LOQ |
| | Pasteurellaceae | <LOQ | <LOQ | <LOQ | <LOQ | <LOQ | <LOQ | <LOQ |
| | Sutterellaceae | 7.52 | 7.54 | 7.83 | 8.08 | 8.12 | 8.16 | 8.11 |
| Verrucomicrobiota | Akkermansiaceae | 5.52 | 5.08 | 5.39 | 5.43 | 5.59 | 5.47 | 5.59 |

48 h

| | | | | | | | | |
|---|---|---|---|---|---|---|---|---|
| Actinobacteria | Atopobiaceae | <LOQ | <LOQ | <LOQ | 4.94 | <LOQ | <LOQ | 4.88 |
| | Bifidobacteriaceae | 7.79 | 8.09 | 8.49 | 8.57 | 8.43 | 8.39 | 8.18 |
| | Coriobacteriaceae | 5.93 | 5.45 | 5.42 | 5.72 | 5.86 | 5.90 | 6.00 |
| | Coriobacteriales_Incertae_Sedis | <LOQ | <LOQ | <LOQ | <LOQ | <LOQ | <LOQ | <LOQ |
| | Eggerthellaceae | 7.58 | 8.03 | 7.27 | 7.38 | 7.24 | 7.31 | 7.53 |
| | uncultured | <LOQ | <LOQ | <LOQ | <LOQ | <LOQ | <LOQ | <LOQ |
| Bacteria | Bacteria_unclassified | 5.25 | <LOQ | 5.16 | 5.19 | 5.19 | 5.10 | 5.06 |
| unclassified | | | | | | | | |
| Bacteroidetes | Bacteroidaceae | 8.37 | 8.80 | 8.16 | 8.38 | 8.51 | 8.60 | 8.68 |
| | Bacteroidales_unclassified | <LOQ | 4.91 | 4.89 | 4.99 | 5.14 | 5.21 | 5.02 |
| | Barnesiellaceae | 5.18 | 4.87 | 5.30 | 5.11 | 5.09 | 5.34 | 5.44 |
| | Marinifilaceae | 5.72 | 4.93 | 5.32 | 5.85 | 6.13 | 6.29 | 6.51 |
| | Prevotellaceae | 5.55 | 6.39 | 5.65 | 6.31 | 6.60 | 6.71 | 7.03 |
| | Rikenellaceae | 6.69 | 6.42 | 6.69 | 6.72 | 6.80 | 6.95 | 7.11 |
| | Tannerellaceae | 7.44 | 6.70 | 7.08 | 7.24 | 7.44 | 7.54 | 7.62 |
| Desulfobacterota | Desulfovibrionaceae | 5.57 | 5.05 | 5.37 | 5.68 | 5.56 | 5.71 | 5.63 |
| Firmicutes | Acidaminococcaceae | 5.42 | 5.44 | 5.35 | 5.39 | 5.53 | 5.53 | 5.70 |
| | Anaerovoracaceae | <LOQ | <LOQ | <LOQ | 4.87 | 4.85 | <LOQ | <LOQ |
| | Butyricicoccaceae | 5.23 | <LOQ | 5.12 | 5.65 | 5.40 | 5.57 | 6.01 |
| | Christensenellaceae | 5.24 | 5.03 | 5.27 | 5.10 | 5.16 | 5.39 | 5.60 |
| | Clostridia_UCG-014_fa | 5.15 | 5.05 | 4.98 | 5.11 | 5.05 | 5.17 | 5.11 |
| | Clostridiaceae | 5.81 | 5.67 | 5.80 | 5.84 | 5.75 | 6.02 | 5.98 |
| | Defluviitaleaceae | <LOQ | <LOQ | <LOQ | <LOQ | <LOQ | <LOQ | <LOQ |
| | Enterococcaceae | 5.58 | 5.70 | 5.42 | 5.39 | 5.51 | 5.59 | 5.74 |
| | Erysipelatoclostridiaceae | <LOQ | <LOQ | 4.89 | 4.93 | 4.94 | 4.87 | 4.85 |
| | Erysipelotrichaceae | 6.30 | 7.48 | 6.69 | 7.11 | 7.03 | 7.00 | 6.89 |
| | Lachnospiraceae | 7.20 | 7.36 | 6.87 | 7.18 | 7.18 | 7.34 | 7.66 |
| | Lactobacillaceae | <LOQ | 5.03 | 5.21 | 5.03 | 4.88 | 5.09 | <LOQ |
| | Monoglobaceae | <LOQ | <LOQ | <LOQ | 4.88 | 5.33 | 5.49 | 5.83 |
| | Oscillospiraceae | 6.41 | 5.58 | 6.04 | 6.30 | 6.31 | 6.51 | 6.73 |
| | Oscillospirales_fa | 5.09 | <LOQ | 5.12 | <LOQ | 4.90 | 4.93 | 4.90 |
| | Peptostreptococcaceae | 5.78 | 5.32 | 5.51 | 5.40 | 5.43 | 5.58 | 5.57 |
| | RF39_fa | 4.88 | <LOQ | <LOQ | <LOQ | 4.85 | <LOQ | <LOQ |
| | Ruminococcaceae | 6.86 | 6.67 | 6.72 | 6.93 | 6.88 | 6.87 | 6.95 |
| | Selenomonadaceae | 5.98 | 6.15 | 6.16 | 6.15 | 6.15 | 6.14 | 6.09 |
| | Streptococcaceae | 5.09 | 5.46 | 5.23 | 5.32 | 5.52 | 5.42 | 5.61 |
| | UCG-010 | <LOQ | <LOQ | <LOQ | <LOQ | <LOQ | <LOQ | <LOQ |
| | Veillonellaceae | 6.09 | 6.51 | 6.11 | 6.15 | 6.06 | 6.29 | 6.42 |
| Proteobacteria | Enterobacteriaceae | 8.59 | 8.73 | 8.44 | 8.45 | 8.51 | 8.54 | 8.65 |
| | Morganellaceae | <LOQ | <LOQ | <LOQ | <LOQ | 4.85 | <LOQ | <LOQ |
| | Oxalobacteraceae | <LOQ | <LOQ | <LOQ | <LOQ | <LOQ | <LOQ | <LOQ |
| | Pasteurellaceae | <LOQ | <LOQ | <LOQ | <LOQ | <LOQ | <LOQ | <LOQ |
| | Sutterellaceae | 7.51 | 7.40 | 7.65 | 7.93 | 7.98 | 7.99 | 7.82 |
| Verrucomicrobiota | Akkermansiaceae | 5.55 | 4.99 | 4.99 | 5.39 | 5.48 | 5.45 | 5.64 |

TABLE 8

| | | | | | | | |
|---|---|---|---|---|---|---|---|
| | | | | 75/25 | 50/50 | 25/75 | |
| Phylum | Family | Inulin | OGF | OGF/CPF | OGF/CPF | OGF/CPF | CPF |

24 h

| | | | | | | | |
|---|---|---|---|---|---|---|---|
| Actinobacteria | Atopobiaceae | −0.01 | −0.01 | 0.02 | −0.01 | −0.01 | 0.01 |
| | Bifidobacteriaceae | 0.34 | 0.63 | 0.60 | 0.52 | 0.50 | 0.35 |
| | Coriobacteriaceae | −0.33 | −0.26 | −0.18 | −0.08 | −0.17 | −0.13 |
| | Coriobacteriales_Incertae_Sedis | 0.00 | 0.00 | 0.00 | 0.00 | 0.00 | 0.00 |
| | Eggerthellaceae | 0.34 | −0.39 | −0.32 | −0.37 | −0.32 | −0.08 |
| | uncultured | 0.00 | 0.00 | 0.00 | 0.00 | 0.00 | 0.00 |
| Bacteria | Bacteria_unclassified | −0.16 | −0.16 | −0.16 | −0.16 | −0.11 | −0.01 |
| unclassified | | | | | | | |
| Bacteroidetes | Bacteroidaceae | 0.39 | −0.02 | 0.15 | 0.21 | 0.23 | 0.33 |
| | Bacteroidales_unclassified | −0.22 | −0.05 | 0.06 | 0.09 | 0.10 | 0.25 |
| | Barnesiellaceae | −0.50 | −0.19 | −0.14 | −0.24 | −0.13 | 0.06 |
| | Marinifilaceae | −0.43 | −0.55 | 0.48 | 0.56 | 0.71 | 0.99 |
| | Prevotellaceae | 1.36 | 0.21 | 0.92 | 1.18 | 1.59 | 1.94 |
| | Rikenellaceae | −0.16 | 0.00 | 0.21 | 0.13 | 0.24 | 0.44 |
| | Tannerellaceae | −0.64 | −0.25 | 0.11 | 0.05 | 0.01 | 0.15 |
| Desulfobacterota | Desulfovibrionaceae | −0.57 | −0.30 | −0.13 | −0.38 | −0.45 | 0.04 |
| Firmicutes | Acidaminococcaceae | 0.01 | −0.17 | −0.06 | −0.10 | −0.10 | −0.02 |
| | Anaerovoracaceae | 0.00 | 0.00 | 0.00 | 0.00 | 0.00 | 0.00 |
| | Butyricicoccaceae | −0.01 | −0.06 | 0.49 | 0.49 | 0.45 | 0.77 |
| | Christensenellaceae | −0.15 | −0.06 | −0.08 | −0.14 | −0.23 | 0.24 |
| | Clostridia_UCG-014_fa | −0.16 | −0.15 | 0.06 | −0.08 | −0.04 | 0.08 |
| | Clostridiaceae | −0.02 | 0.29 | 0.28 | 0.36 | 0.22 | 0.39 |
| | Defluviitaleaceae | 0.00 | 0.00 | 0.00 | 0.00 | 0.00 | 0.00 |
| | Enterococcaceae | 0.07 | −0.20 | −0.11 | −0.09 | −0.18 | 0.11 |
| | Erysipelatoclostridiaceae | 0.00 | 0.04 | 0.28 | 0.08 | 0.19 | 0.02 |
| | Erysipelotrichaceae | 1.04 | 0.61 | 0.76 | 0.47 | 0.37 | 0.37 |
| | Lachnospiraceae | 0.62 | −0.01 | 0.05 | 0.11 | 0.09 | 0.24 |
| | Lactobacillaceae | −0.13 | 0.29 | 0.28 | 0.12 | 0.07 | −0.06 |
| | Monoglobaceae | 0.00 | 0.00 | 0.00 | 0.39 | 0.31 | 0.95 |
| | Oscillospiraceae | −0.71 | −0.34 | 0.12 | 0.09 | 0.12 | 0.36 |
| | Oscillospirales_fa | −0.38 | −0.38 | −0.38 | −0.32 | −0.29 | −0.32 |
| | Peptostreptococcaceae | −0.14 | −0.30 | −0.22 | −0.46 | −0.12 | −0.01 |
| | RF39_fa | 0.00 | 0.00 | 0.04 | 0.00 | 0.00 | 0.00 |
| | Ruminococcaceae | −0.11 | 0.02 | 0.13 | 0.12 | 0.05 | 0.09 |
| | Selenomonadaceae | 0.19 | 0.15 | 0.13 | 0.16 | 0.16 | 0.11 |
| | Streptococcaceae | 0.35 | 0.11 | 0.27 | 0.39 | 0.29 | 0.44 |
| | UCG-010 | 0.00 | 0.00 | 0.00 | 0.00 | 0.00 | 0.00 |
| | Veillonellaceae | 0.28 | −0.16 | −0.12 | 0.00 | 0.02 | 0.20 |
| Proteobacteria | Enterobacteriaceae | −0.04 | −0.36 | −0.27 | −0.35 | −0.29 | −0.03 |
| | Morganellaceae | 0.00 | 0.00 | 0.00 | 0.00 | 0.20 | 0.06 |
| | Oxalobacteraceae | 0.00 | 0.00 | 0.00 | 0.00 | 0.00 | 0.00 |
| | Pasteurellaceae | 0.00 | 0.00 | 0.00 | 0.00 | 0.00 | 0.00 |
| | Sutterellaceae | 0.02 | 0.30 | 0.55 | 0.59 | 0.63 | 0.59 |
| Verrucomicrobiota | Akkermansiaceae | −0.44 | −0.13 | −0.09 | 0.07 | −0.05 | 0.07 |

48 h

| | | | | | | | |
|---|---|---|---|---|---|---|---|
| Actinobacteria | Atopobiaceae | 0.00 | 0.00 | 0.10 | 0.00 | 0.00 | 0.05 |
| | Bifidobacteriaceae | 0.30 | 0.70 | 0.78 | 0.64 | 0.60 | 0.38 |
| | Coriobacteriaceae | −0.48 | −0.50 | −0.20 | −0.07 | −0.02 | 0.07 |
| | Coriobacteriales_Incertae_Sedis | 0.00 | 0.00 | 0.00 | 0.00 | 0.00 | 0.00 |
| | Eggerthellaceae | 0.45 | −0.31 | −0.20 | −0.33 | −0.27 | −0.05 |
| | uncultured | 0.00 | 0.00 | 0.00 | 0.00 | 0.00 | 0.00 |
| Bacteria | Bacteria_unclassified | −0.41 | −0.08 | −0.06 | −0.06 | −0.15 | −0.19 |
| unclassified | | | | | | | |
| Bacteroidetes | Bacteroidaceae | 0.42 | −0.22 | 0.01 | 0.14 | 0.23 | 0.31 |
| | Bacteroidales_unclassified | 0.07 | 0.06 | 0.15 | 0.31 | 0.38 | 0.19 |
| | Barnesiellaceae | −0.31 | 0.12 | −0.07 | −0.09 | 0.16 | 0.26 |
| | Marinifilaceae | −0.80 | −0.40 | 0.13 | 0.40 | 0.57 | 0.79 |
| | Prevotellaceae | 0.84 | 0.10 | 0.75 | 1.05 | 1.16 | 1.48 |
| | Rikenellaceae | −0.27 | 0.00 | 0.03 | 0.11 | 0.26 | 0.42 |
| | Tannerellaceae | −0.74 | −0.35 | −0.20 | 0.00 | 0.11 | 0.18 |
| Desulfobacterota | Desulfovibrionaceae | −0.52 | −0.20 | 0.11 | −0.01 | 0.14 | 0.06 |
| Firmicutes | Acidaminococcaceae | 0.01 | −0.08 | −0.03 | 0.10 | 0.11 | 0.28 |
| | Anaerovoracaceae | 0.00 | 0.00 | 0.03 | 0.02 | 0.00 | 0.00 |
| | Butyricicoccaceae | −0.39 | −0.10 | 0.43 | 0.17 | 0.35 | 0.78 |
| | Christensenellaceae | −0.22 | 0.03 | −0.15 | −0.08 | 0.14 | 0.35 |
| | Clostridia_UCG-014_fa | −0.10 | −0.17 | −0.05 | −0.10 | 0.02 | −0.04 |
| | Clostridiaceae | −0.14 | −0.01 | 0.03 | −0.06 | 0.22 | 0.17 |
| | Defluviitaleaceae | 0.00 | 0.00 | 0.00 | 0.00 | 0.00 | 0.00 |
| | Enterococcaceae | 0.11 | −0.17 | −0.19 | −0.07 | 0.01 | 0.15 |
| | Erysipelatoclostridiaceae | 0.00 | 0.05 | 0.10 | 0.10 | 0.04 | 0.02 |
| | Erysipelotrichaceae | 1.18 | 0.39 | 0.81 | 0.73 | 0.70 | 0.59 |
| | Lachnospiraceae | 0.17 | −0.32 | −0.02 | −0.01 | 0.14 | 0.46 |
| | Lactobacillaceae | 0.19 | 0.37 | 0.20 | 0.04 | 0.26 | 0.00 |
| | Monoglobaceae | 0.00 | 0.00 | 0.05 | 0.49 | 0.66 | 1.00 |
| | Oscillospiraceae | −0.83 | −0.37 | −0.11 | −0.10 | 0.10 | 0.32 |
| | Oscillospirales_fa | −0.26 | 0.03 | −0.26 | −0.20 | −0.16 | −0.20 |
| | Peptostreptococcaceae | −0.46 | −0.28 | −0.39 | −0.36 | −0.20 | −0.21 |
| | RF39_fa | −0.04 | −0.04 | −0.04 | −0.03 | −0.04 | −0.04 |
| | Ruminococcaceae | −0.19 | −0.14 | 0.07 | 0.01 | 0.01 | 0.08 |
| | Selenomonadaceae | 0.17 | 0.18 | 0.17 | 0.17 | 0.16 | 0.11 |
| | Streptococcaceae | 0.36 | 0.14 | 0.23 | 0.43 | 0.32 | 0.51 |
| | UCG-010 | 0.00 | 0.00 | 0.00 | 0.00 | 0.00 | 0.00 |
| | Veillonellaceae | 0.42 | 0.02 | 0.06 | −0.02 | 0.20 | 0.33 |
| Proteobacteria | Enterobacteriaceae | 0.14 | −0.15 | −0.15 | −0.08 | −0.05 | 0.06 |
| | Morganellaceae | 0.00 | 0.00 | 0.00 | 0.02 | 0.00 | 0.00 |
| | Oxalobacteraceae | 0.00 | 0.00 | 0.00 | 0.00 | 0.00 | 0.00 |
| | Pasteurellaceae | 0.00 | 0.00 | 0.00 | 0.00 | 0.00 | 0.00 |
| | Sutterellaceae | −0.11 | 0.14 | 0.42 | 0.48 | 0.48 | 0.31 |
| Verrucomicrobiota | Akkermansiaceae | −0.56 | −0.56 | −0.17 | −0.08 | −0.10 | 0.09 |

TABLE 9

| | | | | | | |
|---|---|---|---|---|---|---|
| | | | 75/25 | 50/50 | 25/75 | |
| Phylum | Family | OGF | OGF/CPF | OGF/CPF | OGF/CPF | CPF |

24 h

| | | | | | | |
|---|---|---|---|---|---|---|
| Actinobacteria | Atopobiaceae | 0.00 | 0.04 | 0.00 | 0.00 | 0.02 |
| | Bifidobacteriaceae | 0.29 | 0.26 | 0.18 | 0.15 | 0.01 |
| | Coriobacteriaceae | 0.08 | 0.15 | 0.25 | 0.16 | 0.21 |
| | Coriobacteriales_Incertae_Sedis | 0.00 | 0.00 | 0.00 | 0.00 | 0.00 |
| | Eggerthellaceae | −0.73 | −0.66 | −0.71 | −0.66 | −0.42 |
| | uncultured | 0.00 | 0.00 | 0.00 | 0.00 | 0.00 |
| Bacteria | Bacteria_unclassified | 0.00 | 0.00 | 0.00 | 0.05 | 0.15 |
| unclassified | | | | | | |
| Bacteroidetes | Bacteroidaceae | −0.41 | −0.24 | −0.19 | −0.16 | −0.07 |
| | Bacteroidales_unclassified | 0.17 | 0.28 | 0.31 | 0.31 | 0.46 |
| | Barnesiellaceae | 0.30 | 0.36 | 0.26 | 0.37 | 0.56 |
| | Marinifilaceae | −0.13 | 0.91 | 0.99 | 1.13 | 1.41 |
| | Prevotellaceae | −1.15 | −0.45 | −0.18 | 0.22 | 0.58 |
| | Rikenellaceae | 0.16 | 0.37 | 0.29 | 0.41 | 0.60 |
| | Tannerellaceae | 0.40 | 0.75 | 0.70 | 0.65 | 0.79 |
| Desulfobacterota | Desulfovibrionaceae | 0.27 | 0.44 | 0.19 | 0.13 | 0.61 |
| Firmicutes | Acidaminococcaceae | −0.18 | −0.08 | −0.11 | −0.11 | −0.03 |
| | Anaerovoracaceae | 0.00 | 0.00 | 0.00 | 0.00 | 0.00 |
| | Butyricicoccaceae | −0.05 | 0.50 | 0.50 | 0.46 | 0.78 |
| | Christensenellaceae | 0.09 | 0.07 | 0.01 | −0.08 | 0.39 |
| | Clostridia_UCG-014_fa | 0.01 | 0.22 | 0.08 | 0.12 | 0.24 |
| | Clostridiaceae | 0.31 | 0.30 | 0.38 | 0.24 | 0.40 |
| | Defluviitaleaceae | 0.00 | 0.00 | 0.00 | 0.00 | 0.00 |
| | Enterococcaceae | −0.27 | −0.19 | −0.17 | −0.26 | 0.04 |
| | Erysipelatoclostridiaceae | 0.04 | 0.28 | 0.08 | 0.19 | 0.02 |
| | Erysipelotrichaceae | −0.43 | −0.28 | −0.57 | −0.67 | −0.67 |
| | Lachnospiraceae | −0.64 | −0.58 | −0.51 | −0.53 | −0.38 |
| | Lactobacillaceae | 0.41 | 0.41 | 0.24 | 0.19 | 0.06 |
| | Monoglobaceae | 0.00 | 0.00 | 0.39 | 0.31 | 0.95 |
| | Oscillospiraceae | 0.37 | 0.83 | 0.80 | 0.82 | 1.06 |
| | Oscillospirales_fa | 0.00 | 0.00 | 0.06 | 0.09 | 0.06 |
| | Peptostreptococcaceae | −0.16 | −0.08 | −0.32 | 0.02 | 0.13 |
| | RF39_fa | 0.00 | 0.04 | 0.00 | 0.00 | 0.00 |
| | Ruminococcaceae | 0.14 | 0.24 | 0.24 | 0.17 | 0.20 |
| | Selenomonadaceae | −0.03 | −0.06 | −0.02 | −0.02 | −0.08 |
| | Streptococcaceae | −0.23 | −0.08 | 0.04 | −0.06 | 0.09 |
| | UCG-010 | 0.00 | 0.00 | 0.00 | 0.00 | 0.00 |
| | Veillonellaceae | −0.44 | −0.40 | −0.28 | −0.26 | −0.07 |
| Proteobacteria | Enterobacteriaceae | −0.32 | −0.23 | −0.31 | −0.25 | 0.01 |
| | Morganellaceae | 0.00 | 0.00 | 0.00 | 0.20 | 0.06 |
| | Oxalobacteraceae | 0.00 | 0.00 | 0.00 | 0.00 | 0.00 |
| | Pasteurellaceae | 0.00 | 0.00 | 0.00 | 0.00 | 0.00 |
| | Sutterellaceae | 0.29 | 0.54 | 0.58 | 0.62 | 0.57 |
| Verrucomicrobiota | Akkermansiaceae | 0.31 | 0.35 | 0.51 | 0.39 | 0.51 |

48 h

| | | | | | | |
|---|---|---|---|---|---|---|
| Actinobacteria | Atopobiaceae | 0.00 | 0.10 | 0.00 | 0.00 | 0.05 |
| | Bifidobacteriaceae | 0.40 | 0.48 | 0.34 | 0.30 | 0.09 |
| | Coriobacteriaceae | −0.03 | 0.27 | 0.41 | 0.45 | 0.55 |
| | Coriobacteriales_Incertae_Sedis | 0.00 | 0.00 | 0.00 | 0.00 | 0.00 |
| | Eggerthellaceae | −0.76 | −0.65 | −0.78 | −0.72 | −0.50 |
| | uncultured | 0.00 | 0.00 | 0.00 | 0.00 | 0.00 |
| Bacteria | Bacteria_unclassified | 0.33 | 0.35 | 0.36 | 0.27 | 0.22 |
| unclassified | | | | | | |
| Bacteroidetes | Bacteroidaceae | −0.64 | −0.42 | −0.28 | −0.20 | −0.12 |
| | Bacteroidales_unclassified | −0.01 | 0.08 | 0.24 | 0.30 | 0.11 |
| | Barnesiellaceae | 0.44 | 0.24 | 0.22 | 0.47 | 0.57 |
| | Marinifilaceae | 0.40 | 0.93 | 1.20 | 1.36 | 1.58 |
| | Prevotellaceae | −0.74 | −0.08 | 0.21 | 0.32 | 0.64 |
| | Rikenellaceae | 0.27 | 0.30 | 0.38 | 0.53 | 0.69 |
| | Tannerellaceae | 0.39 | 0.54 | 0.74 | 0.85 | 0.92 |
| Desulfobacterota | Desulfovibrionaceae | 0.32 | 0.62 | 0.51 | 0.65 | 0.58 |
| Firmicutes | Acidaminococcaceae | −0.09 | −0.05 | 0.09 | 0.09 | 0.27 |
| | Anaerovoracaceae | 0.00 | 0.03 | 0.02 | 0.00 | 0.00 |
| | Butyricicoccaceae | 0.29 | 0.82 | 0.56 | 0.74 | 1.17 |
| | Christensenellaceae | 0.24 | 0.07 | 0.13 | 0.36 | 0.57 |
| | Clostridia_UCG-014_fa | −0.07 | 0.05 | 0.00 | 0.12 | 0.06 |
| | Clostridiaceae | 0.14 | 0.17 | 0.08 | 0.36 | 0.31 |
| | Defluviitaleaceae | 0.00 | 0.00 | 0.00 | 0.00 | 0.00 |
| | Enterococcaceae | −0.28 | −0.30 | −0.18 | −0.10 | 0.04 |
| | Erysipelatoclostridiaceae | 0.05 | 0.10 | 0.10 | 0.04 | 0.02 |
| | Erysipelotrichaceae | −0.79 | −0.37 | −0.45 | −0.48 | −0.59 |
| | Lachnospiraceae | −0.49 | −0.18 | −0.18 | −0.03 | 0.29 |
| | Lactobacilloceae | 0.18 | 0.01 | −0.15 | 0.06 | −0.19 |
| | Monoglobaceae | 0.00 | 0.05 | 0.49 | 0.66 | 1.00 |
| | Oscillospiraceae | 0.46 | 0.72 | 0.73 | 0.93 | 1.15 |
| | Oscillospirales_fa | 0.29 | 0.00 | 0.06 | 0.10 | 0.06 |
| | Peptostreptococcaceae | 0.18 | 0.07 | 0.10 | 0.26 | 0.25 |
| | RF39_fa | 0.00 | 0.00 | 0.02 | 0.00 | 0.00 |
| | Ruminococcaceae | 0.05 | 0.26 | 0.20 | 0.20 | 0.27 |
| | Selenomonadaceae | 0.01 | 0.00 | 0.00 | −0.01 | −0.06 |
| | Streptococcaceae | −0.22 | −0.14 | 0.06 | −0.04 | 0.15 |
| | UCG-010 | 0.00 | 0.00 | 0.00 | 0.00 | 0.00 |
| | Veillonellaceae | −0.40 | −0.36 | −0.45 | −0.22 | −0.09 |
| Proteobacteria | Enterobacteriaceae | −0.28 | −0.28 | −0.21 | −0.19 | −0.07 |
| | Morganellaceae | 0.00 | 0.00 | 0.02 | 0.00 | 0.00 |
| | Oxalobacteraceae | 0.00 | 0.00 | 0.00 | 0.00 | 0.00 |
| | Pasteurellaceae | 0.00 | 0.00 | 0.00 | 0.00 | 0.00 |
| | Sutterellaceae | 0.25 | 0.53 | 0.58 | 0.59 | 0.42 |
| Verrucomicrobiota | Akkermansiaceae | 0.01 | 0.40 | 0.49 | 0.46 | 0.65 |

TABLE 10
24 h

| | | | | | | | 75/25 | 50/50 | 25/75 | |
|---|---|---|---|---|---|---|---|---|---|---|
| | | | Closely Realted | | | | OGF/ | OGF/ | OGF/ | |
| Phylum | Family | OTU | Species | Blank | Inulin | OGF | CPF | CPF | CPF | CPF |
| Actinobacteria | Bifidobacteriaceae | Otu0003 | Bifidobacterium | 7.59 | 8.07 | 8.31 | 8.31 | 8.24 | 8.19 | 8.01 |
| | | | adolescentis | | | | | | | |
| | | Otu0010 | Bifidobacterium | 7.02 | 7.12 | 7.64 | 7.53 | 7.35 | 7.37 | 7.40 |
| | | | longum | | | | | | | |
| | | Otu0019 | Bifidobacterium | 7.03 | 7.12 | 7.29 | 7.31 | 7.13 | 7.19 | 7.13 |
| | | | bifidum | | | | | | | |
| | | Otu0011 | Bifidobacterium | 5.89 | 6.06 | 6.02 | 6.03 | 5.98 | 6.02 | 5.94 |
| | | | angulatum | | | | | | | |
| | | Otu0016 | Bifidobacterium | 6.06 | 6.74 | 6.74 | 6.79 | 6.75 | 6.62 | 6.46 |
| | | | (pseudo)catenulatum | | | | | | | |
| | Coriobacteriaceae | Otu0026 | Collinsella | 6.08 | 5.76 | 5.78 | 5.91 | 6.01 | 5.92 | 5.96 |
| | | | aerofaciens | | | | | | | |
| | Eggerthellaceae | Otu0007 | Senegalimassilia | 7.88 | 8.22 | 7.49 | 7.55 | 7.51 | 7.56 | 7.79 |
| | | | faecalis | | | | | | | |
| Bacteroidetes | Bacteroidaceae | Otu0004 | Bacteroides | 7.95 | 7.73 | 8.05 | 8.21 | 8.27 | 8.33 | 8.42 |
| | | | bouchesdurhonensis | | | | | | | |
| | | Otu0013 | Bacteroides | 7.22 | 7.53 | 6.93 | 7.11 | 7.03 | 7.02 | 7.25 |
| | | | faecis | | | | | | | |
| | | Otu0020 | Bacteroides | 6.31 | 6.35 | 6.13 | 6.52 | 6.61 | 6.68 | 6.68 |
| | | | rodentium | | | | | | | |
| | | Otu0009 | Bacteroides | 7.48 | 8.15 | 7.24 | 7.42 | 7.44 | 7.41 | 7.45 |
| | | | faecis | | | | | | | |
| | | Otu0012 | Bacteroides | 6.86 | 7.83 | 6.99 | 7.10 | 7.16 | 7.19 | 7.35 |
| | | | ovatus | | | | | | | |
| | | Otu0014 | Bacteroides cutis | 6.90 | 7.23 | 6.85 | 7.11 | 7.17 | 7.15 | 7.20 |
| | | Otu0035 | Bacteroides | 5.76 | 5.75 | 5.73 | 5.88 | 6.00 | 6.09 | 6.30 |
| | | | stercoris | | | | | | | |
| | | Otu0021 | Bacteroides | 6.56 | 7.55 | 6.77 | 6.76 | 6.86 | 6.84 | 6.97 |
| | | | luhongzhouii | | | | | | | |
| | | Otu0030 | Bacteroides | 6.53 | 6.55 | 6.41 | 6.37 | 6.50 | 6.45 | 6.52 |
| | | | thetaiotaomicron | | | | | | | |
| | | Otu0017 | Bacteroides | 5.98 | 5.88 | 5.85 | 5.89 | 5.96 | 5.91 | 5.94 |
| | | | luhongzhouii | | | | | | | |
| | Bacteroidales_unclassified | Otu0044 | Bacteroides sp. | 5.22 | <LOQ | 5.21 | 5.31 | 5.32 | 5.34 | 5.48 |
| | Prevotellaceae | Otu0006 | Prevotella | 5.85 | 7.21 | 6.07 | 6.77 | 7.03 | 7.43 | 7.79 |
| | | | hominis | | | | | | | |
| | Tannerellaceae | Otu0018 | Parabacteroides | 7.01 | 6.29 | 6.83 | 7.22 | 7.14 | 7.09 | 7.21 |
| | | | gordonii | | | | | | | |
| | | Otu0029 | Parabacteroides | 5.81 | 5.73 | 5.69 | 5.73 | 5.75 | 5.80 | 5.80 |
| | | | gordonii | | | | | | | |
| Firmicutes | Clostridiaceae | Otu0037 | Clostridium | 5.51 | 5.30 | 5.44 | 5.37 | 5.32 | 5.24 | 5.49 |
| | | | saudiense | | | | | | | |
| | | Otu0038 | Clostridium | 5.31 | 5.48 | 5.69 | 5.78 | 5.81 | 5.83 | 5.76 |
| | | | perfringens | | | | | | | |
| | Erysipelotrichaceae | Otu0008 | Holdemanella | 6.44 | 7.59 | 6.93 | 7.11 | 6.79 | 6.82 | 6.75 |
| | | | sp. | | | | | | | |
| | Lachnospiraceae | Otu0027 | Blautia faecicola | 5.65 | 7.34 | 6.07 | 6.03 | 5.90 | 5.98 | 6.03 |
| | | Otu0025 | Lachnoclostridium | 5.82 | 5.76 | 5.67 | 6.01 | 6.32 | 6.31 | 6.59 |
| | | | pacaense | | | | | | | |
| | Ruminococcaceae | Otu0015 | Faecalibacterium | 6.66 | 6.61 | 6.82 | 6.93 | 6.89 | 6.81 | 6.83 |
| | | | sp. | | | | | | | |
| | Selenomonadaceae | Otu0002 | Megamonas | 6.22 | 6.41 | 6.37 | 6.35 | 6.38 | 6.38 | 6.33 |
| | | | hypermegale | | | | | | | |
| | Veillonellaceae | Otu0028 | Dialister invisus | 5.86 | 5.79 | 5.64 | 5.65 | 5.76 | 5.79 | 5.95 |
| | | Otu0023 | Dialister | 5.67 | 6.01 | 5.72 | 5.77 | 5.76 | 5.75 | 5.80 |
| | | | massiliensis | | | | | | | |
| Proteobacteria | Enterobacteriaceae | Otu0001 | Escherichia coli, | 8.54 | 8.50 | 8.18 | 8.27 | 8.19 | 8.25 | 8.51 |
| | | | E. fergusonii, | | | | | | | |
| | | | Shigella sonnei, | | | | | | | |
| | | | S. flexneri, | | | | | | | |
| | Sutterellaceae | Otu0005 | Pseudescherichia | 7.43 | 7.41 | 7.73 | 7.96 | 8.01 | 8.07 | 8.04 |
| | | | vulneris | | | | | | | |
| | | Otu0022 | Sutterella | 5.66 | 5.59 | 5.65 | 5.84 | 5.83 | 5.84 | 5.86 |
| | | | megalosphaeroides | | | | | | | |

TABLE 11
48 h

| | | | | | | | 75/25 | 50/50 | 25/75 | |
|---|---|---|---|---|---|---|---|---|---|---|
| | | | Closely Realted | | | | OGF/ | OGF/ | OGF/ | |
| Phylum | Family | OTU | Species | Blank | Inulin | OGF | CPF | CPF | CPF | CPF |
| Actinobacteria | Bifidobacteriaceae | Otu0003 | Bifidobacterium | 7.54 | 7.90 | 8.23 | 8.40 | 8.22 | 8.19 | 7.95 |
| | | | adolescentis | | | | | | | |
| | | Otu0010 | Bifidobacterium | 6.91 | 7.04 | 7.59 | 7.55 | 7.42 | 7.50 | 7.37 |
| | | | longum | | | | | | | |
| | | Otu0019 | Bifidobacterium | 6.86 | 6.96 | 7.22 | 7.26 | 7.11 | 7.18 | 6.91 |
| | | | bifidum | | | | | | | |
| | | Otu0011 | Bifidobacterium | 5.64 | 5.81 | 5.87 | 5.91 | 5.86 | 5.86 | 5.75 |
| | | | angulatum | | | | | | | |
| | | Otu0016 | Bifidobacterium | 5.88 | 6.55 | 6.63 | 6.86 | 6.66 | 6.59 | 6.39 |
| | | | (pseudo)catenulatum | | | | | | | |
| | Coriobacteriaceae | Otu0026 | Collinsella | 5.93 | 5.45 | 5.42 | 5.72 | 5.86 | 5.90 | 5.96 |
| | | | aerofaciens | | | | | | | |
| | Eggerthellaceae | Otu0007 | Senegalimassilia | 7.54 | 8.02 | 7.25 | 7.36 | 7.23 | 7.29 | 7.51 |
| | | | faecalis | | | | | | | |
| Bacteroidetes | Bacteroidaceae | Otu0004 | Bacteroides | 8.02 | 7.67 | 7.82 | 8.09 | 8.27 | 8.36 | 8.45 |
| | | | bouchesdurhonensis | | | | | | | |
| | | Otu0013 | Bacteroides | 7.07 | 7.24 | 6.49 | 6.81 | 6.59 | 6.85 | 7.13 |
| | | | faecis | | | | | | | |
| | | Otu0020 | Bacteroides | 6.52 | 6.43 | 6.41 | 6.61 | 6.79 | 6.91 | 6.86 |
| | | | rodentium | | | | | | | |
| | | Otu0009 | Bacteroides | 7.34 | 8.26 | 7.11 | 7.11 | 7.08 | 7.09 | 7.17 |
| | | | faecis | | | | | | | |
| | | Otu0012 | Bacteroides | 6.94 | 7.92 | 6.92 | 6.98 | 7.04 | 7.14 | 7.29 |
| | | | ovatus | | | | | | | |
| | | Otu0014 | Bacteroides cutis | 7.08 | 7.32 | 6.91 | 7.19 | 7.29 | 7.38 | 7.32 |
| | | Otu0035 | Bacteroides | 5.68 | 5.38 | 5.57 | 5.72 | 5.99 | 6.01 | 6.12 |
| | | | stercoris | | | | | | | |
| | | Otu0021 | Bacteroides | 6.62 | 7.70 | 6.57 | 6.64 | 6.34 | 6.73 | 6.86 |
| | | | luhongzhouii | | | | | | | |
| | | Otu0030 | Bacteroides | 6.12 | 6.52 | 5.84 | 6.14 | 6.24 | 6.35 | 6.50 |
| | | | thetaiotaomicron | | | | | | | |
| | | Otu0017 | Bacteroides | 5.83 | 5.70 | 5.59 | 5.66 | 5.75 | 5.81 | 5.87 |
| | | | luhongzhouii | | | | | | | |
| | Bacteroidales_unclassified | Otu0044 | Bacteroides sp. | <LOQ | 4.91 | 4.89 | 4.99 | 5.13 | 5.20 | 5.02 |
| | Prevotellaceae | Otu0006 | Prevotella | 5.53 | 6.24 | 5.65 | 6.30 | 6.60 | 6.71 | 7.02 |
| | | | hominis | | | | | | | |
| | Tannerellaceae | Otu0018 | Parabacteroides | 7.23 | 6.37 | 6.98 | 7.15 | 7.31 | 7.39 | 7.42 |
| | | | gordonii | | | | | | | |
| | | Otu0029 | Parabacteroides | 5.72 | 5.57 | 5.48 | 5.45 | 5.58 | 5.70 | 5.73 |
| | | | gordonii | | | | | | | |
| Firmicutes | Clostridiaceae | Otu0037 | Clostridium | 5.71 | 5.40 | 5.42 | 5.43 | 5.32 | 5.52 | 5.40 |
| | | | saudiense | | | | | | | |
| | | Otu0038 | Clostridium | 4.88 | 5.23 | 5.21 | 5.31 | 5.35 | 5.47 | 5.53 |
| | | | perfringens | | | | | | | |
| | Erysipelotrichaceae | Otu0008 | Holdemanella | 6.04 | 7.26 | 6.47 | 6.87 | 6.82 | 6.78 | 6.61 |
| | | | sp. | | | | | | | |
| | Lachnospiraceae | Otu0027 | Blautia faecicola | 5.66 | 6.85 | 5.76 | 6.06 | 6.07 | 5.97 | 6.30 |
| | | Otu0025 | Lachnoclostridium | 6.36 | 6.37 | 6.01 | 6.31 | 6.23 | 6.49 | 6.79 |
| | | | pacaense | | | | | | | |
| | Ruminococcaceae | Otu0015 | Faecalibacterium | 6.73 | 6.58 | 6.63 | 6.83 | 6.79 | 6.80 | 6.84 |
| | | | sp. | | | | | | | |
| | Selenomonadaceae | Otu0002 | Megamonas | 5.98 | 6.15 | 6.16 | 6.15 | 6.15 | 6.14 | 6.09 |
| | | | hypermegale | | | | | | | |
| | Veillonellaceae | Otu0028 | Dialister invisus | 5.37 | 5.57 | 5.44 | 5.38 | 5.30 | 5.45 | 5.55 |
| | | Otu0023 | Dialister | 5.52 | 5.78 | 5.50 | 5.60 | 5.60 | 5.62 | 5.67 |
| | | | massiliensis | | | | | | | |
| Proteobacteria | Enterobacteriaceae | Otu0001 | Escherichia coli, | 8.59 | 8.73 | 8.44 | 8.44 | 8.51 | 8.54 | 8.65 |
| | | | E. fergusonii, | | | | | | | |
| | | | Shigella sonnei, | | | | | | | |
| | | | S. flexneri, | | | | | | | |
| | Sutterellaceae | Otu0005 | Pseudescherichia | 7.42 | 7.10 | 7.57 | 7.86 | 7.90 | 7.92 | 7.75 |
| | | | vulneris | | | | | | | |
| | | Otu0022 | Sutterella | 5.51 | 5.60 | 5.64 | 5.71 | 5.73 | 5.64 | 5.57 |
| | | | megalosphaeroides | | | | | | | |

TABLE 12
24 h

| | | | | | | 75/25 | 50/50 | 25/75 | |
|---|---|---|---|---|---|---|---|---|---|
| | | | Closely Realted | | | OGF/ | OGF/ | OGF/ | |
| Phylum | Family | OTU | Species | Inulin | OGF | CPF | CPF | CPF | CPF |
| Actinobacteria | Bifidobacteriaceae | Otu0003 | Bifidobacterium | 0.48 | 0.72 | 0.73 | 0.65 | 0.60 | 0.43 |
| | | | adolescentis | | | | | | |
| | | Otu0010 | Bifidobacterium | 0.10 | 0.61 | 0.51 | 0.33 | 0.35 | 0.38 |
| | | | longum | | | | | | |
| | | Otu0019 | Bifidobacterium | 0.09 | 0.26 | 0.29 | 0.10 | 0.16 | 0.11 |
| | | | bifidum | | | | | | |
| | | Otu0011 | Bifidobacterium | 0.17 | 0.13 | 0.14 | 0.09 | 0.12 | 0.05 |
| | | | angulatum | | | | | | |
| | | Otu0016 | Bifidobacterium | 0.68 | 0.68 | 0.73 | 0.70 | 0.56 | 0.40 |
| | | | (pseudo)catenulatum | | | | | | |
| | Coriobacteriaceae | Otu0026 | Collinsella | −0.33 | −0.30 | −0.17 | −0.07 | −0.17 | −0.12 |
| | | | aerofaciens | | | | | | |
| | Eggerthellaceae | Otu0007 | Senegalimassilia | 0.35 | −0.38 | −0.32 | −0.36 | −0.31 | −0.08 |
| | | | faecalis | | | | | | |
| Bacteroidetes | Bacteroidaceae | Otu0004 | Bacteroides | −0.22 | 0.10 | 0.26 | 0.32 | 0.38 | 0.47 |
| | | | bouchesdurhonensis | | | | | | |
| | | Otu0013 | Bacteroides | 0.31 | −0.29 | −0.11 | −0.19 | −0.20 | 0.03 |
| | | | faecis | | | | | | |
| | | Otu0020 | Bacteroides | 0.04 | −0.17 | 0.21 | 0.30 | 0.37 | 0.37 |
| | | | rodentium | | | | | | |
| | | Otu0009 | Bacteroides | 0.68 | −0.24 | −0.06 | −0.04 | −0.07 | −0.03 |
| | | | faecis | | | | | | |
| | | Otu0012 | Bacteroides | 0.96 | 0.12 | 0.23 | 0.30 | 0.33 | 0.49 |
| | | | ovatus | | | | | | |
| | | Otu0014 | Bacteroides cutis | 0.33 | −0.05 | 0.21 | 0.27 | 0.25 | 0.31 |
| | | Otu0035 | Bacteroides | 0.00 | −0.03 | 0.12 | 0.25 | 0.34 | 0.55 |
| | | | stercoris | | | | | | |
| | | Otu0021 | Bacteroides | 0.99 | 0.21 | 0.20 | 0.30 | 0.28 | 0.42 |
| | | | luhongzhouii | | | | | | |
| | | Otu0030 | Bacteroides | 0.02 | −0.12 | −0.16 | −0.03 | −0.09 | −0.01 |
| | | | thetaiotaomicron | | | | | | |
| | | Otu0017 | Bacteroides | −0.10 | −0.13 | −0.10 | −0.03 | −0.07 | −0.04 |
| | | | luhongzhouii | | | | | | |
| | Bacteroidales_unclassified | Otu0044 | Bacteroides sp. | −0.17 | −0.01 | 0.10 | 0.10 | 0.13 | 0.26 |
| | Prevotellaceae | Otu0006 | Prevotella | 1.36 | 0.22 | 0.91 | 1.18 | 1.58 | 1.94 |
| | | | hominis | | | | | | |
| | Tannerellaceae | Otu0018 | Parabacteroides | −0.71 | −0.18 | 0.21 | 0.13 | 0.09 | 0.20 |
| | | | gordonii | | | | | | |
| | | Otu0029 | Parabacteroides | −0.08 | −0.13 | −0.09 | −0.06 | −0.01 | −0.02 |
| | | | gordonii | | | | | | |
| Firmicutes | Clostridiaceae | Otu0037 | Clostridium | −0.21 | −0.07 | −0.14 | −0.20 | −0.28 | −0.03 |
| | | | saudiense | | | | | | |
| | | Otu0038 | Clostridium | 0.17 | 0.38 | 0.47 | 0.50 | 0.52 | 0.45 |
| | | | perfringens | | | | | | |
| | Erysipelotrichaceae | Otu0008 | Holdemanella | 1.15 | 0.48 | 0.67 | 0.35 | 0.38 | 0.31 |
| | | | sp. | | | | | | |
| | Lachnospiraceae | Otu0027 | Blautia faecicola | 1.69 | 0.42 | 0.37 | 0.24 | 0.33 | 0.38 |
| | | Otu0025 | Lachnoclostridium | −0.06 | −0.14 | 0.19 | 0.50 | 0.50 | 0.77 |
| | | | pacaense | | | | | | |
| | Ruminococcaceae | Otu0015 | Faecalibacterium | −0.05 | 0.16 | 0.27 | 0.23 | 0.16 | 0.17 |
| | | | sp. | | | | | | |
| | Selenomonadaceae | Otu0002 | Megamonas | 0.18 | 0.15 | 0.13 | 0.16 | 0.16 | 0.11 |
| | | | hypermegale | | | | | | |
| | Veillonellaceae | Otu0028 | Dialister invisus | −0.07 | −0.22 | −0.21 | −0.10 | −0.08 | 0.09 |
| | | Otu0023 | Dialister | 0.34 | 0.05 | 0.10 | 0.09 | 0.08 | 0.12 |
| | | | massiliensis | | | | | | |
| Proteobacteria | Enterobacteriaceae | Otu0001 | Escherichia coli, | −0.04 | −0.36 | −0.27 | −0.35 | −0.29 | −0.03 |
| | | | E. fergusonii, | | | | | | |
| | | | Shigella sonnei, | | | | | | |
| | | | S. flexneri, | | | | | | |
| | Sutterellaceae | Otu0005 | Pseudescherichia | −0.03 | 0.30 | 0.53 | 0.58 | 0.64 | 0.61 |
| | | | vulneris | | | | | | |
| | | Otu0022 | Sutterella | −0.07 | −0.01 | 0.18 | 0.17 | 0.18 | 0.20 |
| | | | megalosphaeroides | | | | | | |

TABLE 13
48 h

| | | | | | | 75/25 | 50/50 | 25/75 | |
|---|---|---|---|---|---|---|---|---|---|
| | | | Closely Realted | | | OGF/ | OGF/ | OGF/ | |
| Phylum | Family | OTU | Species | Inulin | OGF | CPF | CPF | CPF | CPF |
| Actinobacteria | Bifidobacteriaceae | Otu0003 | Bifidobacterium | 0.36 | 0.69 | 0.86 | 0.68 | 0.65 | 0.41 |
| | | | adolescentis | | | | | | |
| | | Otu0010 | Bifidobacterium | 0.13 | 0.68 | 0.64 | 0.51 | 0.59 | 0.46 |
| | | | longum | | | | | | |
| | | Otu0019 | Bifidobacterium | 0.10 | 0.36 | 0.40 | 0.25 | 0.32 | 0.05 |
| | | | bifidum | | | | | | |
| | | Otu0011 | Bifidobacterium | 0.17 | 0.22 | 0.26 | 0.22 | 0.22 | 0.10 |
| | | | angulatum | | | | | | |
| | | Otu0016 | Bifidobacterium | 0.67 | 0.75 | 0.98 | 0.78 | 0.71 | 0.51 |
| | | | (pseudo)catenulatum | | | | | | |
| | Coriobacteriaceae | Otu0026 | Collinsella | −0.48 | −0.50 | −0.20 | −0.07 | −0.02 | 0.03 |
| | | | aerofaciens | | | | | | |
| | Eggerthellaceae | Otu0007 | Senegalimassilia | 0.48 | −0.29 | −0.18 | −0.32 | −0.26 | −0.03 |
| | | | faecalis | | | | | | |
| Bacteroidetes | Bacteroidaceae | Otu0004 | Bacteroides | −0.35 | −0.21 | 0.07 | 0.25 | 0.33 | 0.42 |
| | | | bouchesdurhonensis | | | | | | |
| | | Otu0013 | Bacteroides | 0.17 | −0.58 | −0.26 | −0.47 | −0.22 | 0.07 |
| | | | faecis | | | | | | |
| | | Otu0020 | Bacteroides | −0.09 | −0.11 | 0.08 | 0.27 | 0.38 | 0.34 |
| | | | rodentium | | | | | | |
| | | Otu0009 | Bacteroides | 0.92 | −0.23 | −0.23 | −0.26 | −0.25 | −0.17 |
| | | | faecis | | | | | | |
| | | Otu0012 | Bacteroides | 0.99 | −0.01 | 0.05 | 0.10 | 0.20 | 0.35 |
| | | | ovatus | | | | | | |
| | | Otu0014 | Bacteroides cutis | 0.24 | −0.17 | 0.10 | 0.21 | 0.30 | 0.24 |
| | | Otu0035 | Bacteroides | −0.30 | −0.11 | 0.04 | 0.30 | 0.32 | 0.44 |
| | | | stercoris | | | | | | |
| | | Otu0021 | Bacteroides | 1.08 | −0.05 | 0.01 | −0.29 | 0.11 | 0.24 |
| | | | luhongzhouii | | | | | | |
| | | Otu0030 | Bacteroides | 0.40 | −0.28 | 0.02 | 0.12 | 0.23 | 0.38 |
| | | | thetaiotaomicron | | | | | | |
| | | Otu0017 | Bacteroides | −0.14 | −0.25 | −0.17 | −0.08 | −0.02 | 0.03 |
| | | | luhongzhouii | | | | | | |
| | Bacteroidales_unclassified | Otu0044 | Bacteroides sp. | 0.07 | 0.06 | 0.15 | 0.30 | 0.37 | 0.19 |
| | Prevotellaceae | Otu0006 | Prevotella | 0.70 | 0.12 | 0.77 | 1.06 | 1.18 | 1.49 |
| | | | hominis | | | | | | |
| | Tannerellaceae | Otu0018 | Parabacteroides | −0.86 | −0.25 | −0.08 | 0.09 | 0.16 | 0.19 |
| | | | gordonii | | | | | | |
| | | Otu0029 | Parabacteroides | −0.16 | −0.25 | −0.27 | −0.14 | −0.02 | 0.01 |
| | | | gordonii | | | | | | |
| Firmicutes | Clostridiaceae | Otu0037 | Clostridium | −0.30 | −0.29 | −0.27 | −0.39 | −0.18 | −0.31 |
| | | | saudiense | | | | | | |
| | | Otu0038 | Clostridium | 0.35 | 0.33 | 0.43 | 0.47 | 0.59 | 0.65 |
| | | | perfringens | | | | | | |
| | Erysipelotrichaceae | Otu0008 | Holdemanella | 1.23 | 0.44 | 0.83 | 0.79 | 0.74 | 0.57 |
| | | | sp. | | | | | | |
| | Lachnospiraceae | Otu0027 | Blautia faecicola | 1.19 | 0.10 | 0.40 | 0.40 | 0.31 | 0.64 |
| | | Otu0025 | Lachnoclostridium | 0.01 | −0.35 | −0.05 | −0.13 | 0.13 | 0.43 |
| | | | pacaense | | | | | | |
| | Ruminococcaceae | Otu0015 | Faecalibacterium | −0.15 | −0.09 | 0.10 | 0.07 | 0.07 | 0.11 |
| | | | sp. | | | | | | |
| | Selenomonadaceae | Otu0002 | Megamonas | 0.17 | 0.18 | 0.17 | 0.17 | 0.16 | 0.11 |
| | | | hypermegale | | | | | | |
| | Veillonellaceae | Otu0028 | Dialister invisus | 0.20 | 0.07 | 0.01 | −0.08 | 0.08 | 0.17 |
| | | Otu0023 | Dialister | 0.26 | −0.02 | 0.08 | 0.08 | 0.09 | 0.15 |
| | | | massiliensis | | | | | | |
| Proteobacteria | Enterobacteriaceae | Otu0001 | Escherichia coli, | 0.14 | −0.15 | −0.15 | −0.08 | −0.05 | 0.06 |
| | | | E. fergusonii, | | | | | | |
| | | | Shigella sonnei, | | | | | | |
| | | | S. flexneri, | | | | | | |
| | Sutterellaceae | Otu0005 | Pseudescherichia | −0.32 | 0.15 | 0.44 | 0.48 | 0.50 | 0.33 |
| | | | vulneris | | | | | | |
| | | Otu0022 | Sutterella | 0.09 | 0.13 | 0.20 | 0.22 | 0.14 | 0.07 |
| | | | megalosphaeroides | | | | | | |

TABLE 14
24 h

| | | | | | 75/25 | 50/50 | 25/75 | |
|---|---|---|---|---|---|---|---|---|
| | | | Closely Realted | | OGF/ | OGF/ | OGF/ | |
| Phylum | Family | OTU | Species | OGF | CPF | CPF | CPF | CPF |
| Actinobacteria | Bifidobacteriaceae | Otu0003 | Bifidobacterium | 0.24 | 0.24 | 0.16 | 0.12 | −0.06 |
| | | | adolescentis | | | | | |
| | | Otu0010 | Bifidobacterium | 0.51 | 0.41 | 0.22 | 0.25 | 0.28 |
| | | | longum | | | | | |
| | | Otu0019 | Bifidobacterium | 0.17 | 0.20 | 0.02 | 0.07 | 0.02 |
| | | | bifidum | | | | | |
| | | Otu0011 | Bifidobacterium | −0.05 | −0.03 | −0.08 | −0.05 | −0.12 |
| | | | angulatum | | | | | |
| | | Otu0016 | Bifidobacterium | 0.00 | 0.05 | 0.02 | −0.11 | −0.27 |
| | | | (pseudo)catenulatum | | | | | |
| | Coriobacteriaceae | Otu0026 | Collinsella | 0.02 | 0.15 | 0.25 | 0.16 | 0.21 |
| | | | aerofaciens | | | | | |
| | Eggerthellaceae | Otu0007 | Senegalimassilia | −0.73 | −0.67 | −0.71 | −0.66 | −0.43 |
| | | | faecalis | | | | | |
| Bacteroidetes | Bacteroidaceae | Otu0004 | Bacteroides | 0.32 | 0.49 | 0.54 | 0.61 | 0.69 |
| | | | bouchesdurhonensis | | | | | |
| | | Otu0013 | Bacteroides | −0.61 | −0.42 | −0.50 | −0.51 | −0.28 |
| | | | faecis | | | | | |
| | | Otu0020 | Bacteroides | −0.22 | 0.17 | 0.26 | 0.33 | 0.33 |
| | | | rodentium | | | | | |
| | | Otu0009 | Bacteroides | −0.92 | −0.73 | −0.71 | −0.75 | −0.70 |
| | | | faecis | | | | | |
| | | Otu0012 | Bacteroides | −0.84 | −0.73 | −0.67 | −0.64 | −0.47 |
| | | | ovatus | | | | | |
| | | Otu0014 | Bacteroides cutis | −0.38 | −0.12 | −0.06 | −0.08 | −0.02 |
| | | Otu0035 | Bacteroides | −0.02 | 0.12 | 0.25 | 0.34 | 0.55 |
| | | | stercoris | | | | | |
| | | Otu0021 | Bacteroides | −0.78 | −0.78 | −0.69 | −0.71 | −0.57 |
| | | | luhongzhouii | | | | | |
| | | Otu0030 | Bacteroides | −0.14 | −0.18 | −0.05 | −0.10 | −0.03 |
| | | | thetaiotaomicron | | | | | |
| | | Otu0017 | Bacteroides | −0.03 | 0.01 | 0.07 | 0.03 | 0.06 |
| | | | luhongzhouii | | | | | |
| | Bacteroidales_unclassified | Otu0044 | Bacteroides sp. | 0.17 | 0.27 | 0.28 | 0.30 | 0.43 |
| | Prevotellaceae | Otu0006 | Prevotella | −1.15 | −0.45 | −0.18 | 0.22 | 0.58 |
| | | | hominis | | | | | |
| | Tannerellaceae | Otu0018 | Parabacteroides | 0.53 | 0.93 | 0.85 | 0.80 | 0.91 |
| | | | gordonii | | | | | |
| | | Otu0029 | Parabacteroides | −0.05 | −0.01 | 0.02 | 0.07 | 0.06 |
| | | | gordonii | | | | | |
| Firmicutes | Clostridiaceae | Otu0037 | Clostridium | 0.14 | 0.07 | 0.02 | −0.06 | 0.19 |
| | | | saudiense | | | | | |
| | | Otu0038 | Clostridium | 0.20 | 0.30 | 0.33 | 0.35 | 0.28 |
| | | | perfringens | | | | | |
| | Erysipelotrichaceae | Otu0008 | Holdemanella | −0.67 | −0.48 | −0.80 | −0.77 | −0.84 |
| | | | sp. | | | | | |
| | Lachnospiraceae | Otu0027 | Blautia faecicola | −1.27 | −1.31 | −1.44 | −1.36 | −1.31 |
| | | Otu0025 | Lachnoclostridium | −0.08 | 0.25 | 0.56 | 0.56 | 0.83 |
| | | | pacaense | | | | | |
| | Ruminococcaceae | Otu0015 | Faecalibacterium | 0.21 | 0.32 | 0.28 | 0.21 | 0.22 |
| | | | sp. | | | | | |
| | Selenomonadaceae | Otu0002 | Megamonas | −0.03 | −0.06 | −0.02 | −0.02 | −0.08 |
| | | | hypermegale | | | | | |
| | Veillonellaceae | Otu0028 | Dialister invisus | −0.15 | −0.14 | −0.03 | 0.00 | 0.17 |
| | | Otu0023 | Dialister | −0.29 | −0.24 | −0.25 | −0.26 | −0.22 |
| | | | massiliensis | | | | | |
| Proteobacteria | Enterobacteriaceae | Otu0001 | Escherichia coli, | −0.32 | −0.23 | −0.31 | −0.25 | 0.01 |
| | | | E. fergusonii, | | | | | |
| | | | Shigella sonnei, | | | | | |
| | | | S. flexneri, | | | | | |
| | Sutterellaceae | Otu0005 | Pseudescherichia | 0.33 | 0.56 | 0.61 | 0.66 | 0.63 |
| | | | vulneris | | | | | |
| | | Otu0022 | Sutterella | 0.06 | 0.25 | 0.24 | 0.25 | 0.27 |
| | | | megalosphaeroides | | | | | |

TABLE 15
48 h

| | | | | | 75/25 | 50/50 | 25/75 | |
|---|---|---|---|---|---|---|---|---|
| | | | Closely Realted | | OGF/ | OGF/ | OGF/ | |
| Phylum | Family | OTU | Species | OGF | CPF | CPF | CPF | CPF |
| Actinobacteria | Bifidobacteriaceae | Otu0003 | Bifidobacterium | 0.33 | 0.50 | 0.32 | 0.29 | 0.05 |
| | | | adolescentis | | | | | |
| | | Otu0010 | Bifidobacterium | 0.54 | 0.50 | 0.38 | 0.45 | 0.32 |
| | | | longum | | | | | |
| | | Otu0019 | Bifidobacterium | 0.26 | 0.30 | 0.15 | 0.22 | −0.05 |
| | | | bifidum | | | | | |
| | | Otu0011 | Bifidobacterium | 0.06 | 0.10 | 0.05 | 0.05 | −0.06 |
| | | | angulatum | | | | | |
| | | Otu0016 | Bifidobacterium | 0.08 | 0.31 | 0.11 | 0.04 | −0.16 |
| | | | (pseudo)catenulatum | | | | | |
| | Coriobacteriaceae | Otu0026 | Collinsella | −0.03 | 0.27 | 0.41 | 0.45 | 0.51 |
| | | | aerofaciens | | | | | |
| | Eggerthellaceae | Otu0007 | Senegalimassilia | −0.76 | −0.66 | −0.79 | −0.73 | −0.51 |
| | | | faecalis | | | | | |
| Bacteroidetes | Bacteroidaceae | Otu0004 | Bacteroides | 0.14 | 0.42 | 0.60 | 0.68 | 0.77 |
| | | | bouchesdurhonensis | | | | | |
| | | Otu0013 | Bacteroides | −0.75 | −0.42 | −0.64 | −0.38 | −0.10 |
| | | | faecis | | | | | |
| | | Otu0020 | Bacteroides | −0.02 | 0.18 | 0.36 | 0.48 | 0.43 |
| | | | rodentium | | | | | |
| | | Otu0009 | Bacteroides | −1.16 | −1.15 | −1.19 | −1.17 | −1.09 |
| | | | faecis | | | | | |
| | | Otu0012 | Bacteroides | −1.00 | −0.94 | −0.89 | −0.78 | −0.63 |
| | | | ovatus | | | | | |
| | | Otu0014 | Bacteroides cutis | −0.41 | −0.13 | −0.03 | 0.06 | 0.00 |
| | | Otu0035 | Bacteroides | 0.19 | 0.34 | 0.61 | 0.63 | 0.74 |
| | | | stercoris | | | | | |
| | | Otu0021 | Bacteroides | −1.13 | −1.07 | −1.37 | −0.97 | −0.84 |
| | | | luhongzhouii | | | | | |
| | | Otu0030 | Bacteroides | −0.68 | −0.38 | −0.28 | −0.17 | −0.02 |
| | | | thetaiotaomicron | | | | | |
| | | Otu0017 | Bacteroides | −0.11 | −0.04 | 0.05 | 0.11 | 0.17 |
| | | | luhongzhouii | | | | | |
| | Bacteroidales_unclassified | Otu0044 | Bacteroides sp. | −0.01 | 0.08 | 0.23 | 0.29 | 0.11 |
| | Prevotellaceae | Otu0006 | Prevotella | −0.59 | 0.07 | 0.36 | 0.47 | 0.79 |
| | | | hominis | | | | | |
| | Tannerellaceae | Otu0018 | Parabacteroides | 0.61 | 0.78 | 0.94 | 1.02 | 1.05 |
| | | | gordonii | | | | | |
| | | Otu0029 | Parabacteroides | −0.09 | −0.12 | 0.01 | 0.13 | 0.16 |
| | | | gordonii | | | | | |
| Firmicutes | Clostridiaceae | Otu0037 | Clostridium | 0.02 | 0.03 | −0.09 | 0.12 | −0.01 |
| | | | saudiense | | | | | |
| | | Otu0038 | Clostridium | −0.03 | 0.08 | 0.12 | 0.24 | 0.29 |
| | | | perfringens | | | | | |
| | Erysipelotrichaceae | Otu0008 | Holdemanella | −0.79 | −0.40 | −0.44 | −0.48 | −0.66 |
| | | | sp. | | | | | |
| | Lachnospiraceae | Otu0027 | Blautia faecicola | −1.09 | −0.79 | −0.79 | −0.88 | −0.55 |
| | | Otu0025 | Lachnoclostridium | −0.37 | −0.06 | −0.14 | 0.12 | 0.42 |
| | | | pacaense | | | | | |
| | Ruminococcaceae | Otu0015 | Faecalibacterium | 0.05 | 0.25 | 0.21 | 0.21 | 0.26 |
| | | | sp. | | | | | |
| | Selenomonadaceae | Otu0002 | Megamonas | 0.01 | 0.00 | 0.00 | −0.01 | −0.06 |
| | | | hypermegale | | | | | |
| | Veillonellaceae | Otu0028 | Dialister invisus | −0.13 | −0.19 | −0.27 | −0.12 | −0.02 |
| | | Otu0023 | Dialister | −0.28 | −0.18 | −0.18 | −0.16 | −0.10 |
| | | | massiliensis | | | | | |
| Proteobacteria | Enterobacteriaceae | Otu0001 | Escherichia coli, | −0.28 | −0.28 | −0.21 | −0.19 | −0.07 |
| | | | E. fergusonii, | | | | | |
| | | | Shigella sonnei, | | | | | |
| | | | S. flexneri, | | | | | |
| | Sutterellaceae | Otu0005 | Pseudescherichia | 0.47 | 0.76 | 0.80 | 0.83 | 0.66 |
| | | | vulneris | | | | | |
| | | Otu0022 | Sutterella | 0.04 | 0.11 | 0.13 | 0.04 | −0.03 |
| | | | megalosphaeroides | | | | | |

The following paragraphs describe statistically significant enrichments of the most abundant OTUs across the donors, as those are least vulnerable to interindividual differences and thus expected to occur in a broader human population. Data on individual donors can be found in a supplementary excel file.

### Positive Control Inulin

Positive control inulin stimulated members of the families Bifidobacteriaceae, Bacteroidaceae, Coriobacteriaceae, Erysopelotrichaceae and Lachnospiraceae across donors. Bifidobacteriaceae members belonged to the genus Bifidobacterium, bacteria that produce acetate and lactate. Enrichments within the other bacterial families involved Bacteroides species (OTU9, OTU12 and OTU21 (Bacteroidaceae)), Senegalimassilia species (OTU7 (Coriobacteriaceae)), Holdemanella species (OTU8 (Erysipelotrichaceae)) and Blautia species (OTU27 (Lachnospiraceae)). The metabolic function of Senegalimassilia species remains unknown; Bacteroides species produce propionate and acetate, Holdemanella species produce acetate and lactate, and Blautia species produce acetate, lactate, propionate and butyrate.

### Pure Products OGF and CPF

OGF stimulated members of the families Bifidobacteriaceae and Lachnospiraceae across donors. Bifidobacteriaceae members belonged to the genus Bifidobacterium (OTU3, OTU10, OTU19 and OTU16), bacteria that produce acetate and lactate. Lachnospiraceae members belonged to the genus Blautia (OTU27), bacteria that produce acetate, lactate, propionate and butyrate.

CPF stimulated members of the families Bifidobacteriaceae, Prevotellaceae, Butyricicoccaceae, Erysopelotrichaceae, Bacteroidaceae, Monoglobaceae and Lachnospiraceae across donors. A very strong stimulatory effect on Prevotellaceae was observed, attributed to the enrichment of Prevotella species (OTU6), which produce acetate and succinate. Enrichment of Bacteroidaceae involved Bacteroides species (OTU4 and OTU12, acetate/propionate producers), enrichment of Lachnospiraceae involved Blautia species (OTU27, acetate/lactate/propionate/butyrate producers) and enrichment of Bifidobacteriaceae involved Bifidobacterium species (OTU19, acetate/lactate producers). Enrichments of genera of the other bacterial families (Monoglobaceae, Butyricicoccaceae and Erysipelotrichaceae) were distributed over multiple genera, and therefore not statistically significant across donors at the genus level (likely due to interindividual differences).

### Product Mixes

### 75/25 OGF/CPF

75/25 OGF/CPF stimulated members of the families Bifidobacteriaceae, Marinifilaceae, Butyricicoccaceae, Lachnospiraceae and Erysipelotrichaceae across donors. Bifidobacteriaceae members belonged to the genus Bifidobacterium (OTU3, OTU10, OTU19 and OTU16), bacteria that produce acetate and lactate. Lachnospiraceae members belonged to the genus Blautia (OTU27), bacteria that produce acetate, lactate, propionate and butyrate. Enrichments of genera of the other bacterial families (Marinifilaceae, Butyricicoccaceae and Erysipelotrichaceae) were distributed over multiple genera, and therefore not statistically significant across donors at the genus level (likely due to interindividual differences).

### 50/50 OGF/CPF

50/50 OGF/CPF stimulated members of the families Bifidobacteriaceae, Bacteroidaceae, Monoglobaceae, Butyricicoccaceae and Erysipelotrichaceae across donors. Bifidobacteriaceae members belonged to the genus Bifidobacterium (OTU3, OTU16 and OTU19), bacteria that produce acetate and lactate. Bacteroidaceae members belonged to the genus Bacteroides (OTU4 and OTU14), bacteria that produce acetate and propionate. Enrichments of genera of the other bacterial families (Monoglobaceae, Butyricicoccaceae and Erysipelotrichaceae) were distributed over multiple genera, and therefore not statistically significant across donors at the genus level (likely due to interindividual differences).

### 25/75 OGF/CPF

25/75 OGF/CPF stimulated members of the families Bifidobacteriaceae, Bacteroidaceae, Monoglobaceae, Prevotellaceae and Veillonellaceae across donors. A very strong stimulatory effect on Prevotellaceae was observed, attributed to the enrichment of Prevotella species (OTU6), which produce acetate and succinate. Bifidobacteriaceae members belonged to the genus Bifidobacterium (OTU3, OTU10, OTU16 and OTU19), bacteria that produce acetate and lactate. Bacteroidaceae members belonged to the genus Bacteroides (OTU4 and OTU14), bacteria that produce acetate and propionate. Enrichments of genera of the other bacterial families (Monoglobaceae and Veillonellaceae) were distributed over multiple genera, and therefore not statistically significant across donors at the genus level (likely due to interindividual differences).

The test products consisted of mixtures of oat grain flour (OGF) and chickpea flour (CPF), in different ratios. A negative control (blank) and a positive control (inulin) were included as reference conditions.

As OGF and CPF contain a fraction of digestible compounds that, in vivo, is absorbed at the level of the small intestine following their conversion to small molecules, each product was pre-digested prior to colonic incubation. Simulation of small intestinal absorption was performed by means of dialysis. To optimize comparability of data across the different conditions, it was decided to pre-digest inulin and the blank (water) also, knowing that because of its high purity most of the inulin product would reach the colon in vivo.

pH profiles indicated that the fermentation processes in the colonic simulations proceeded under conditions optimal to support growth of a wide diversity of gut microbial community members, enabling cross-feeding interactions (leading to production of secondary metabolites propionate and/or butyrate), if any.

The test products were efficiently fermented. Inulin was more resistant to fermentation than the test products, resulting in a slower fermentation. Amongst the test products, CPF was more difficult to ferment than OGF, illustrated by the fact that pH decreases, gas production, lactate production, and acetate production at 6 h decreased with increasing CPF content in the products. Production of bCFA increased with increasing CPF content, which aligns with the fact that that (pre-digested) CPF contained more protein than (pre-digested) OGF.

All test products and inulin stimulated production of primary metabolites acetate and lactate. OGF, CPF and the mixes thereof generated similar acetate concentrations, but none of them yielded significantly more acetate than inulin (due to interindividual differences). Lactate production increased with OGF content of the product, and OGF and 75/25 OGF/CPF yielded more lactate than inulin in each donor.

All products and inulin stimulated propionate and butyrate production. However, none of the test products consistently yielded more propionate or butyrate than inulin. In donors A and C, propionate production increased with CPF content, whereas butyrate production increased with OGF content. This suggests that CPF drove the fermentation towards propionate production, and OGF drove the fermentation towards butyrate production. In donor B, different propionate and butyrate production profiles were obtained (interindividual variability), in the sense that propionate production increased with OGF content and that similar butyrate concentrations were obtained for all five test products.

In terms of gas production, all test products and inulin stimulated gas production, but the test products yielded significantly less gas than inulin. This can be considered a positive outcome as it reduces the risk of discomfort for the host. However, no major differences were observed between the test products.

Both substrates (OGF and CPF) enriched a different set of bacteria. CPF enriched a wider bacterial diversity than OGF (based on Shannon diversity index). OGF mostly stimulated Bifidobacterium species, and stimulatory effects on butyrate production were probably due to the enrichment of Blautia species. On the contrary, CPF mostly stimulated Bacteroides species, which are specialized in fermenting (resistant) plant-derived glycans, and Prevotella species, which are known to produce succinate (besides acetate). These enrichments may have stimulated propionate production through the succinate-pathway, by delivering succinate produced by Prevotella species to Bacteroides species. These observations likely explain why OGF drove the fermentation to butyrate production, whereas CPF drove the fermentation to propionate production.

Generally, the abundance of an OTU that was enriched either by OGF or CPF, increased with the proportion of respectively OGF or CPF in the test product. In that sense, 75/25 OGF/CPF showed most similarities with OGF in terms of shifts in community composition, and stimulatory effects of members of the genera Bifidobacterium and Blautia were observed. However, the product also enriched Erysipelotrichaceae, and to a lesser extent Marinifilaceae and Butyricicoccaceae. Vice versa, 25/75 OGF/CPF showed most similarities with CPF, as it also enriched Prevotella and Bacteroides species. Stimulation of Bifidobacterium species was much more pronounced versus CPF, likely mediated by the OGF fraction in the product (25%). To a much lesser extent, this product enriched Monoglobaceae and Veillonellaceae. Finally, the 50/50 mix mostly enriched Bifidobacterium (˜OGF) and Bacteroides (˜CPF) species, but also members of bacterial families Erysipelotrichaceae and to a lesser extent Butyricicoccaceae.

All patents and published patent applications referred to herein are incorporated herein by reference. The invention has been described with reference to various specific and embodiments and techniques. Nevertheless, it is understood that many variations and modifications may be made while remaining within the spirit and scope of the invention.

1. A plant-based beverage comprising:
(a) an amount of a first liquid;
(b) an amount of an oat-derived protein; and
(c) an amount of a chickpea-derived protein.

2. The beverage of claim 1, further comprising a prebiotic fiber.

3. The beverage of claim 2, wherein the prebiotic fiber is one of inulin, fructo-oligosaccharides, galactooligosaccharides.

4. The beverage of claim 3, wherein the prebiotic fiber is inulin.

5. The beverage of claim 2, wherein the prebiotic fiber is a human milk oligosaccharide.

6. The beverage of claim 5, wherein the human milk oligosaccharide is one of 2-fucosyllactose, 3-fucosyllactose, difucosyllactose, sialyllactose, 3′sialyllactose, 6′sialyllactose lacto-N-tetraose (LNT), and/or lacto-N-neotetraose.

7. The beverage of claim 1, further comprising an amount of fat.

8. The beverage of claim 7, wherein the fat is a plant-based fat.

9. The beverage of claim 6, wherein the fat is sunflower oil.

10. The beverage of claim 1, further comprising an amount of a vitamin.

11. The beverage of claim 1, further comprising an amount of a first mineral

12. The beverage of claim 1, wherein the first liquid is apple juice.

13. The beverage of claim 1, wherein the amount of oat-derived protein is between 0.01 percent and 6.2 percent of the total weight of the plant-based beverage.

14. The beverage claim 1, wherein the amount of chickpea-derived protein is between 0.01 percent and 6.2 percent of the total weight of the plant-based beverage.

15.-19. (canceled)

20. A method of altering the microbiome in the gastrointestinal tract of a subject, the method comprising:
orally administering to the subject the plant-based beverage of claim 1 so as to alter the microbiome in the gastrointestinal tract of the subject as compared to an untreated control.

21. (canceled)

22. (canceled)

23. The method according to claim 20, wherein the amount of a bifidobacterial or a bacteroides in the gastrointestinal tract of the subject are increased as compared to an untreated control.

24. The method according to claim 20, wherein the bifidobacteria are selected from the group consisting of B. adolescentis, B. longum, B. bifidum, B. angulatum, and B. catenulatum.

25. The method according to claim 20, wherein the bacteroides are selected from the group consisting of B. bouchesdurhonensis, B. faecis, B. rodentium, B. ovatus, B. cutis, B. stercoris, B. luhongahouii, and B. thetaiotaomicron.

26. A method of reducing gas production the gastrointestinal tract of a subject, the method comprising:
orally administering to the subject the plant-based beverage of claim 1;
c) wherein the plant-based beverage comprises inulin; and
wherein the amount of gas produced in the gastrointestinal tract of the subject is reduced as compared to a control administered inulin alone.

27.-37. (canceled)

38. The beverage of claim 1, wherein the oat-derived protein and/or the chickpea-derived protein is hydrolyzed protein.
